(19) United States
(12) Patent Application Publication
(10) Pub. No.: US 2026/0212191 A1
(43) Pub. Date: Jul. 23, 2026

(54) DISTRIBUTED INFRASTRUCTURE FOR TRAINING AND TESTING OF AI SYSTEMS AND APPLICATIONS USING SYNTHETIC DATA GENERATION

(71) Applicant: NVIDIA CORPORATION, Santa Clara, CA (US)

(72) Inventors: Arun Shamanna Lakshmi, San Jose, CA (US); Eric Matthew Colter, Rockford, MI (US)

(21) Appl. No.: 19/035,458

(22) Filed: Jan. 23, 2025

Related U.S. Application Data
(63) Continuation of application No. 19/035,411, filed on Jan. 23, 2025.

(51) Int. Cl. G06N 3/09; B25J 9/16

(52) U.S. Cl. CPC G06N 3/09; B25J 9/163

(57) ABSTRACT

Supervised learning and synthetic data generation may be implemented at scale using a hub-and-spoke model of data centers or clusters in which all spoke data centers connect and share data via high bandwidth connections to a networked file system in the hub data center. For example, multiple instances of a (e.g., robotics) foundation model may be trained in one or more training clusters (e.g., in a hub data center) using synthetic video generated by multiple instances of a simulation environment (e.g., NVIDIA Isaac Sim) in parallel in one or more simulation clusters (e.g., in one or more spoke data centers). Parallel synthetic data generation may continuously generate synthetic data, and parallel supervised learning jobs may continuously generate an updated model using the latest synthetic data as training data. The present techniques may be used to train and/or test humanoid robots, physical AI, or other AI systems and applications.

### CROSS-REFERENCE TO RELATED APPLICATIONS

This application claims the benefit of U.S. App. Ser. No. 19/035,411, filed on Jan. 23, 2025, the contents of which are hereby incorporated by reference in their entirety.

### BACKGROUND

Physical artificial intelligence (AI) refers to systems in which artificial intelligence is used to control machines that interact physically with the real world. Examples of physical AI include autonomous vehicles, industrial robots, delivery drones, humanoid robots, surgical robots, and smart warehouse systems. Whereas generative AI has helped transform digital tasks in recent years, physical AI extends its capabilities into physical environments, enabling robots and other autonomous or semi-autonomous machines to perform complex, real-world operations. The development of these systems has been accelerating thanks to advancements in computing power, machine learning models, and simulations, which allow machines to sense, learn, and adapt to dynamic surroundings. As a result, physical AI is likely to transform industries like logistics, manufacturing, and transportation in the near future.

Robots are one of the primary examples of physical AI. For example, humanoid robots are robots designed to resemble and/or mimic the movements, behaviors, and/or capabilities of humans. They typically include features like a head, torso, arms, legs, and sensors that allow them to navigate and interact with environments built for people, such as homes, offices, or factories. Depending on the objective, humanoid robots may be designed to walk, lift objects, interact with people, or perform other tasks similar to the way humans would—without having to adapt the world to the robot due to its design being similar to that of the humans the world has been designed for. Humanoid robots may leverage a variety of different types of neural networks and control systems working together to function. These neural networks may take the form of a foundation model—such as large language models (LLMs), vision-language models (VLMs), or multimodal language models (MMLMs) that undergo extensive pre-training on vast amounts of unlabeled data—that supports capabilities like understanding and responding to spoken commands, recognizing and interacting with objects, locomotion and navigation, and perception.

However, conventional techniques for physical AI and robotics development have various drawbacks, often resulting from the lack of a scalable approach to training, testing, and deployment of machine learning models. Each of these stages has distinct goals and demands. Training machine learning models—particularly large ones like robotics foundation models—often requires substantial computer resources to process large datasets and run complex algorithms, so it may be desirable to perform training on high-performance computing systems or supercomputers. Once trained, the models are often tested in environments (e.g., simulations or physical testing setups) that mimic or represent the real-world to ensure they can handle real-life situations. After testing, the models may be deployed onto the robot, which often has limited compute resources compared to the more powerful systems typically used during training. One of the primary challenges is creating a seamless workflow where machine learning models trained on powerful systems can be tested in realistic conditions and then adapted to run efficiently on less powerful robotics hardware without losing functionality or performance. Conventional development techniques often separate training (or different types of training), testing, and/or runtime computation into distinct phases. However, since these phases often operate independently, optimizations made in one stage may not carry over effectively to the next, resulting in inconsistent performance, increased development time, and limited scalability.

As such, there is a need for improved techniques for training, testing, and/or deploying large-scale models such as foundation models for humanoid robots and/or other workflows that rely on multiple compute phases.

### SUMMARY

Embodiments of the present disclosure relate to distributed training and testing of humanoid robots, physical AI, or other AI systems and applications.

In some embodiments, different types of compute tasks or phases (e.g., supervised learning, reinforcement learning, synthetic data generation, hardware-in-the-loop testing or validation, etc.) may each run at scale within corresponding clusters of compute nodes, the compute nodes in each cluster may use specialized hardware tailored to a corresponding task, and the tasks running the different clusters may collectively operate in a loop using the output of one task as the input to the next. For example, parallel supervised learning jobs may continuously apply the latest set of skills or experiences learned during reinforcement learning to generate an updated model, and parallel reinforcement learning jobs may continuously use the latest version of the model to learn new skills or experiences. Other possible loops which additionally or alternatively may be distributed across multiple clusters include synthetic data generation interleaved with supervised learning, reinforcement learning interleaved with synthetic data generation and supervised learning, hardware-in-the-loop testing with simulation interleaved with supervised and/or reinforcement learning, and/or others.

In some embodiments, these training and/or testing loops may be implemented at scale using a hub-and-spoke model of data centers or clusters in which all spoke data centers connect and share data via high bandwidth connections to a networked file system in the hub data center. Each spoke may include one or more compute clusters, and the hub may include zero or more compute clusters, a (e.g., fast-tier) networked file system that all compute nodes in all clusters and data centers may access, and (e.g., a slow-tier) object storage which may be scaled as large as needed for a specified workflow. Data that is not actively used may be backed up in object storage, and when data is needed for a scheduled (e.g., training) job, it may be copied from object storage to the networked file system. All compute clusters across all data centers may communicate with each other by reading and/or writing data to the networked file system, eliminating the need for direct cluster-to-cluster communication and corresponding complex routing configurations while delivering high performance.

As such, the techniques described herein may be used to accelerate the training, testing, and/or deployment of large-scale models such as foundation models for humanoid robots and/or other workflows that rely on fast data sharing and distributed computation (e.g., across different types of compute nodes).

### BRIEF DESCRIPTION OF THE DRAWINGS

The present systems and methods for distributed training and testing of humanoid robots, physical AI, or other AI systems and applications are described in detail below with reference to the attached drawing figures, wherein:

FIG. 1 is a block diagram of an example robotics development system, in accordance with some embodiments of the present disclosure;

FIG. 2 is a block diagram of an example distributed infrastructure, in accordance with some embodiments of the present disclosure;

FIGS. 3A and 3B are block diagrams of an example distributed infrastructure for synthetic data generation, in accordance with some embodiments of the present disclosure;

FIGS. 4A and 4B are block diagrams of an example distributed infrastructure for supervised learning, in accordance with some embodiments of the present disclosure;

FIGS. 5A and 5B are block diagrams of an example distributed infrastructure with circular workflows, in accordance with some embodiments of the present disclosure;

FIG. 6 is a flow diagram illustrating a method for running supervised learning and reinforcement learning in a cyclic workflow, in accordance with some embodiments of the present disclosure;

FIG. 7 is a flow diagram illustrating a method for concurrently executing synthetic data generation, supervised learning, and reinforcement learning, in accordance with some embodiments of the present disclosure;

FIG. 8 is a flow diagram illustrating a method for running supervised learning and synthetic data generation in at least one of a hub data center or one or more spoke data centers, in accordance with some embodiments of the present disclosure;

FIG. 9 is a flow diagram illustrating a method for running supervised learning and reinforcement learning in at least one of a hub data center or one or more spoke data centers, in accordance with some embodiments of the present disclosure;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11 is a block diagram of an example computing device suitable for use in implementing at least some embodiments of the present disclosure;

FIG. 12 is a block diagram of an example data center suitable for use in implementing at least some embodiments of the present disclosure;

FIG. 13A is an illustration of an example autonomous vehicle, in accordance with some embodiments of the present disclosure;

FIG. 13B is an example of camera locations and fields of view for the example autonomous vehicle of FIG. 13A, in accordance with some embodiments of the present disclosure;

FIG. 13C is a block diagram of an example system architecture for the example autonomous vehicle of FIG. 13A, in accordance with some embodiments of the present disclosure; and

FIG. 13D is a system diagram for communication between cloud-based server(s) and the example autonomous vehicle of FIG. 13A, in accordance with some embodiments of the present disclosure.

### DETAILED DESCRIPTION

Systems and methods are disclosed relating to distributed training and testing of humanoid robots, autonomous mobile robots (AMRs), autonomous and semi-autonomous machines, physical AI, and/or other AI systems and applications, such as those that use synthetic data generation, reinforcement learning, and/or supervised learning.

In some embodiments, different types of compute tasks or phases (e.g., supervised learning, reinforcement learning, synthetic data generation, hardware-in-the-loop testing or validation) may each run at scale within corresponding clusters of compute nodes, the compute nodes in each cluster may use specialized hardware tailored to a corresponding task, and the tasks running the different clusters may collectively operate in a loop using the output of one task as the input to the next. For example, parallel supervised learning jobs may continuously apply the latest set of skills or experiences learned during reinforcement learning to generate an updated model, and parallel reinforcement learning jobs may continuously use the latest version of the model to learn new skills or experiences. Other possible loops which may be distributed across multiple clusters include synthetic data generation interleaved with supervised learning, reinforcement learning interleaved with synthetic data generation and supervised learning, hardware-in-the-loop testing (e.g., using edge hardware—such as NVIDIA's AGX (e.g., NVIDIA's Xavier, Orin, Thor or other/future generation systems-on-a-chip (SOCs))—within a simulation or other testing environment, and outside of the edge device) with simulation interleaved with supervised and/or reinforcement learning, and/or others. In some embodiments, these training and/or testing loops may be implemented at scale using a hub-and-spoke model of data centers or clusters in which all spoke data centers connect and share data via high bandwidth connections to a networked file system in the hub data center. As such, compared to prior techniques, the techniques described herein may be used to accelerate the training, testing, and/or deployment of large-scale models such as foundation models for humanoid robots and/or other workflows that rely on fast data sharing and distributed computation (e.g., across different types of compute nodes).

In some embodiments, one or more neural networks (e.g., language model(s) such as LLM(s), VLM(s), or MMLM(s), large action models (LAMs), foundation model(s) for humanoid robots, etc.) may be trained and/or tested using specialized hardware and a distributed computing infrastructure. For example, ray-tracing accelerators such as graphics processing units (GPUs) that have ray-tracing cores may be used to run physics-based simulations for reinforcement learning or synthetic data generation, AI or deep learning accelerators such as GPUs that have tensor cores (hardware units that accelerate matrix multiplications) may be used to run supervised learning, and/or edge accelerators such as GPUs with internal or external specialized cores (e.g., tensor cores, digital signal processors (DSPs), dedicated hardware units tailored to specific AI operations like object detection or facial recognition, etc.) optimized for efficient or low-power inference at the edge may be used for hardware-in-the-loop testing or validation.

Taking a robotics foundation model (such as a world foundation model (WFM)) such as Project Generalist Robot 00 Technology (GR00T) or NVIDIA Cosmos as an example, the robotics foundation model may comprise a model or an ensemble of constituent models that form a MMLM and constitute a robot brain. For example, the robotics foundation model may use inputs such as sensor data (e.g., from cameras, LIDAR sensors, microphones, etc.) and (e.g., multimodal) instructions (e.g., natural language commands, visual inputs such as images or video of a demonstration or instructions, detected movement or gestures representing a demonstration or instructions, etc.) to generate specific actions (e.g., encoded as discrete commands, control signals for the robot's actuators, trajectories, control policies) for the robot to execute, carry out tasks, and adapt to their environment in real-time or near real-time.

The robotics foundation model or WFM (or one or more constituent models) may be trained using supervised learning, reinforcement learning, and/or imitation learning using different types of training data, such as text (e.g., representing instructions or commands to perform tasks), images or video (e.g., visual examples of demonstrations or objects), audio (e.g., spoken instructions or environmental sounds), other types of sensor data (e.g., LiDAR data, haptic feedback, etc.), recorded task behaviors or sequences of robot actions (e.g., encoding demonstrations for imitation learning), and/or others.

In some embodiments, multiple instances of the foundation model may be trained in parallel using supervised learning on a first type of compute node (e.g., AI nodes or deep learning nodes equipped with AI or deep learning accelerators), synthetic data for the supervised learning may be generated in multiple jobs running in parallel on a second type of compute node (e.g., rendering nodes equipped with ray-tracing accelerators), and the supervised learning and synthetic data generation may run in parallel in a loop. Additionally or alternatively, multiple instances of the foundation model may be trained using reinforcement and/or imitation learning in a simulation running on the second type of compute node (e.g., rendering nodes equipped with ray-tracing accelerators), and the reinforcement/imitation learning and supervised learning may run in parallel in a loop. In some embodiments, hardware-in-the-loop testing or validation may be implemented by running multiple instances of at least a portion of a physical deployment of the robot (e.g., including the foundation model or WFM) on a third type of compute node (e.g., edge nodes equipped with edge accelerators) in communication with a simulation controlling multiple instances of a digital twin of the robot running on the second type of compute node (e.g., rendering nodes equipped with ray-tracing accelerators), such that the actions generated by the robot may be used to control its digital twin and update the simulation, and the updated simulation may be used to generate virtual sensor data that is applied to the robot to generate actions, and the process may run in a loop. In some embodiments, a compute orchestration service (e.g., NVIDIA OSMO) may be used to coordinate the training, inference, and/or testing workflows on corresponding training clusters of AI nodes or deep learning nodes, simulation clusters of rendering nodes, and/or robot clusters of edge nodes across any number of data centers, cloud providers, and/or clusters.

As such, to support training models such as large-scale (e.g., robotics) foundation models, it may be desirable to have different types of compute nodes working together. However, cloud providers typically avoid placing different types of compute nodes such as AI accelerators (e.g., NVIDIA DGX with H100 GPUs) and ray-tracing accelerators (e.g., NVIDIA OVX with L40 GPUs) in the same cluster because their workloads have significantly different performance profiles, resource demands, and networking requirements. Mixing them can lead to inefficient resource utilization, as the GPUs optimized for one workload may not handle another efficiently, creating bottlenecks. Furthermore, these clusters typically use customized hardware and software stacks tailored to their specific use cases, such as high-bandwidth networking for training versus lower latency for rendering. Keeping them separate ensures optimal performance, scalability, and cost-efficiency for each workload type. As such, the different types of compute nodes involved in large scale training and/or testing workflows will rarely, if ever, be found in a single cluster. Moreover, due to the substantial quantity of compute nodes involved in large scale training and/or testing workflows, it is hard or even impossible to find the desired number of compute nodes in a single data center, as cloud providers typically limit the number of compute nodes they will wire together in a single cluster. As a result, the compute nodes may be divided into clusters and split among different data centers. This introduces several challenges. For example, many training use cases may require nodes to share data quickly, but typically only nodes within a given cluster communicate with each other through fast, direct connections, and clusters within different data centers cannot easily communicate with each other with high bandwidth. As a result, the inability of nodes in different clusters or data centers to communicate with high bandwidth creates bottlenecks, slowing down the training process for large-scale models that rely on fast data sharing and distributed computation across different types of compute nodes.

As such, in some embodiments, clusters of compute nodes and/or data centers may be connected in a hub-and-spoke model in which a hub data center or cluster comprising a first type of compute node and one or more spoke data centers or clusters comprising one or more other types of compute nodes (in the same or different data centers as the hub) may be connected through fast, high-bandwidth connections. Each spoke may include one or more compute clusters, and the hub may include zero or more compute clusters, a (e.g., fast-tier) networked file system that all compute nodes in all clusters and data centers may access, and (e.g., a slow-tier) object storage which may be scaled as large as needed for a specified workflow. Data that is not actively used may be backed up in object storage, and when data is needed for a scheduled (e.g., training) job, it may be copied from object storage to the networked file system. This model enables scaling to a large number of diverse types of compute nodes that would be difficult or even impossible to access from a single data center or cloud provider. All compute clusters across all data centers may communicate with each other by reading and/or writing data to the networked file system, eliminating the need for direct cluster-to-cluster communication and corresponding complex routing configurations while delivering high performance. Furthermore, a two-tiered storage system with a relatively fast but small networked file system and a relatively slow but large object storage provides the benefits of both a high-throughput networked file system and the large capacity of object storage.

Continuing with the example involving a (e.g., robotics and/or world) foundation model, multiple instances of the robotics foundation model may be trained in each of one or more training clusters (e.g., in a hub data center) using synthetic video generated by multiple instances of a simulation environment (e.g., NVIDIA Isaac Sim and/or Drive Sim) in parallel in one or more simulation clusters (e.g., in one or more spoke data centers). Each of the instances of the simulation environment may generate a corresponding video, which may be written to the networked file system and asynchronously backed up to the object storage. As such, the synthetic video (e.g., and/or other training data such as videos scraped, written to the networked file system, and backed up to the object storage by a cluster in the hub or spoke data center) may be moved from the object storage to the networked file system (if necessary) and used to train multiple instances of the foundation model using supervised learning in the one or more training clusters with high-bandwidth access to the training data in the networked file system. Multiple (e.g., AI nodes or deep learning) nodes may be used to run a single instance of the foundation model, and different instances of the foundation model may communicate with each other frequently to synchronize gradients. As such, the supervised learning and synthetic data generation may run in parallel, continuously generating and training with new videos in a loop.

In some embodiments, multiple instances of the latest version of the (e.g., robotics) foundation model may be trained using reinforcement learning running in multiple instances of a simulation environment (e.g., NVIDIA Isaac Sim) in parallel in one or more simulation clusters (e.g., in one or more spoke data centers) to generate a representation of learned skills or experiences (e.g., represented as corresponding sets of deltas), and multiple instances of the foundation model may be trained using supervised learning in each of one or more training clusters (e.g., in a hub data center) using the learned skills or experiences to generate improved versions of the foundation model (e.g., NVIDIA's GR00T, NVIDIA's Cosmos, etc.). The training cluster(s) may retrieve the latest skills or experiences and training data (e.g., synthetic and/or real videos) from the networked file system, use supervised learning to generate improved version(s) of the foundation model, and store the improved version(s) of the foundation model in the networked file system. As such, the simulation cluster(s) may retrieve the latest version of the foundation model and input data (e.g., visual inputs such as images or video of a demonstration or instructions), apply the input data to multiple instances of the latest version of the foundation model to determine actions for the robot to perform, apply the actions to a corresponding digital twin in a corresponding instance of a simulated environment to generate a representation of a corresponding learned skill or experience, and store the learned skills or experiences in the networked file system. As such, the reinforcement learning and supervised learning may run in parallel, continuously generating improved versions of the foundation model, using the improved versions to generate learned skills or experiences, and using the learned skills or experiences to generate improved versions of the foundation model.

In some embodiments, multiple instances of at least a portion of a physical deployment of the robot (including the foundation model) may be operated in one or more robot clusters (e.g., in a hub data center) in communication with one or more simulation clusters running multiple instances of a simulation environment (e.g., NVIDIA Isaac Sim) in parallel (e.g., in the hub data center). Each of the instances of the simulation environment may render virtual sensor data, which may be transmitted to a corresponding robot. As such, the virtual sensor data may be applied to a corresponding robot in the robot cluster(s) to generate a corresponding action (e.g., actuation signals), which may be sent back to a corresponding instance of the simulation environment and used to control a corresponding digital twin of the robot, update the simulation, and generate updated virtual sensor data, and the process may repeat in a loop. In some embodiments, this hardware-in-the-loop testing or validation may be performed in parallel with supervised learning in one or more training clusters (e.g., in one or more spoke data centers) that generate and store improved versions of the foundation model in the networked file system, such that the robot cluster(s) may retrieve the latest version of the foundation model from the networked file system, load it onto the robots in the robot cluster(s), and test the behavior of latest version of the foundation model on the actual robot in a hardware-in-the-loop setup. As such, hardware-in-the-loop testing or validation and supervised learning may run in parallel, continuously generating improved versions of the foundation model, and using the improved versions for hardware-in-the-loop testing or validation. These are just a few examples, and the hub-and-spoke model may be used to implement other types of workflows that rely on fast data sharing and distributed computation across different types of compute nodes within the scope of the present disclosure.

As such, the techniques described herein may be used to train and/or test neural networks such as large-scale foundation models (e.g., robotic or world foundation models) using specialized hardware and/or a distributed computing infrastructure. The present techniques facilitate faster and more efficient data sharing and distributed computation across different types of compute nodes across different clusters, data centers, and/or cloud providers than in prior techniques, particularly when the scale of the workflow is so large that the different types of compute nodes are unavailable from a single data center or cloud provider.

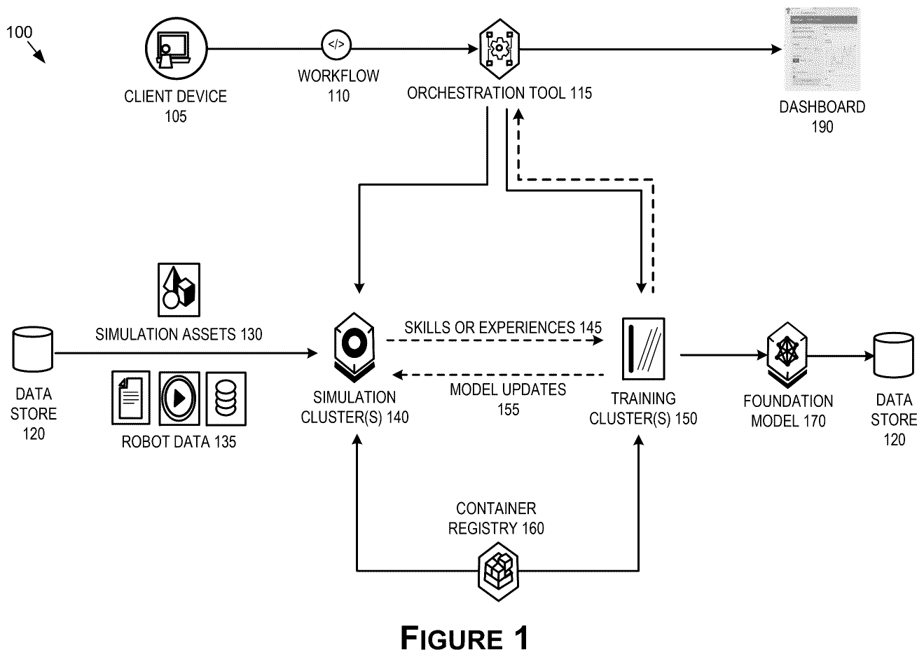

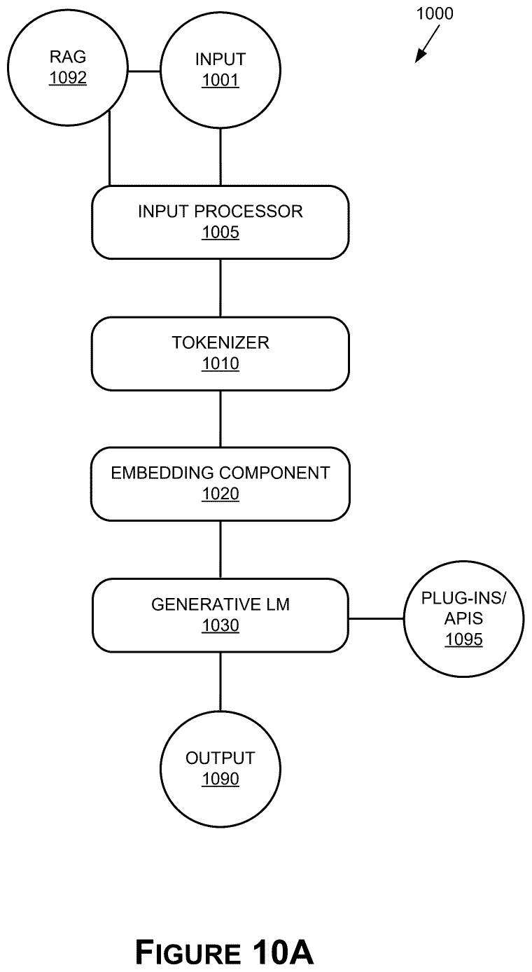

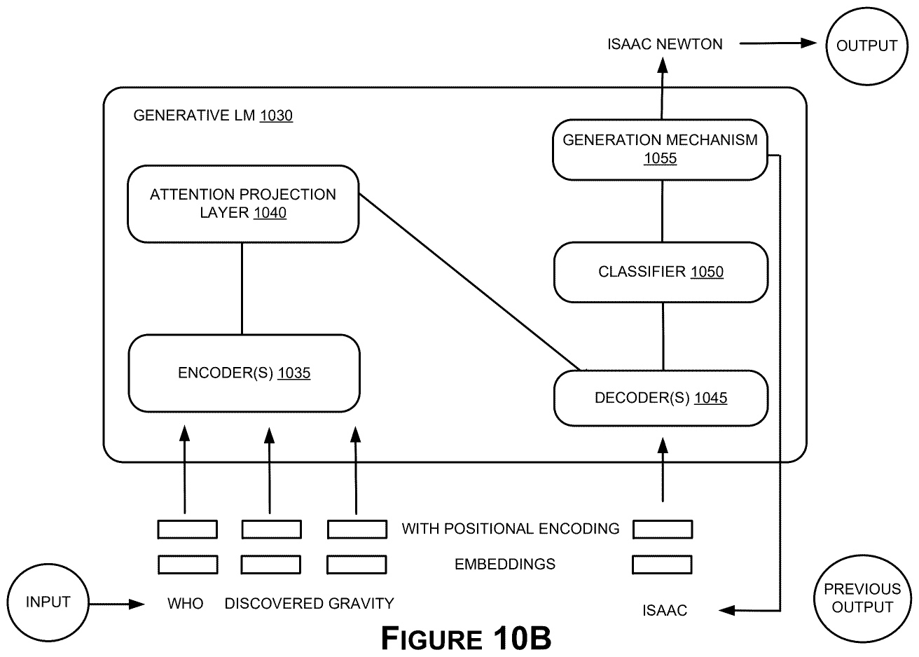

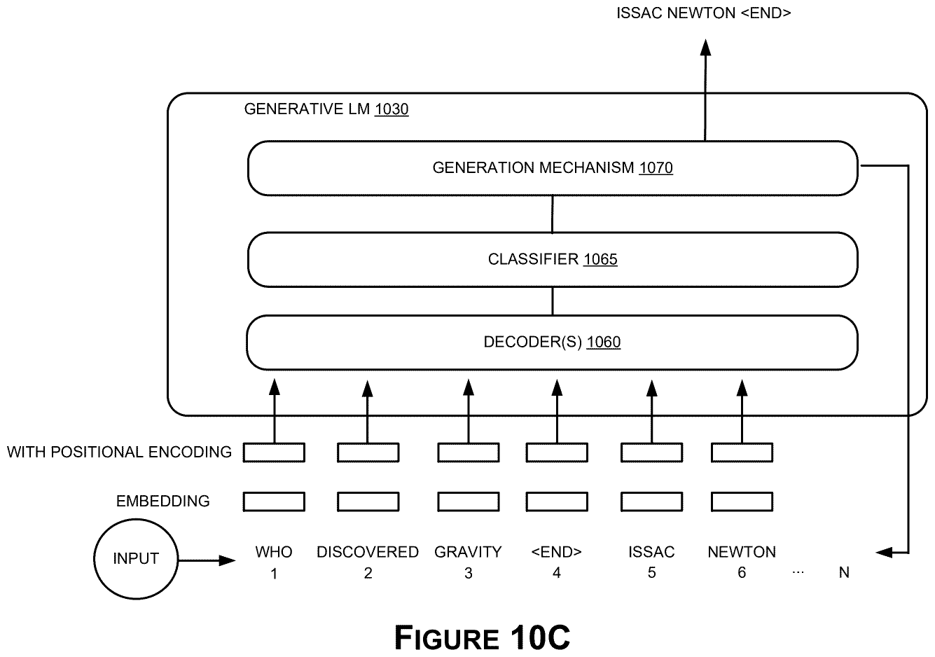

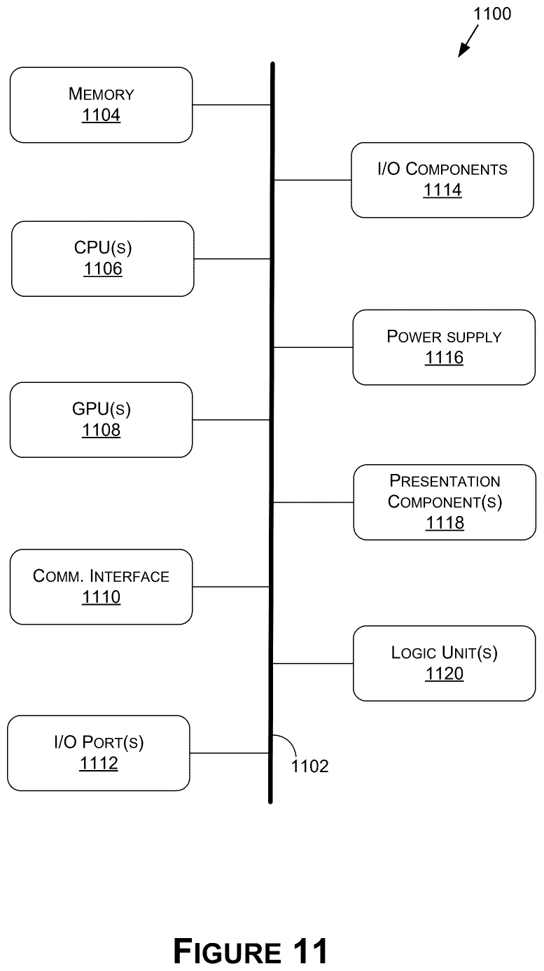

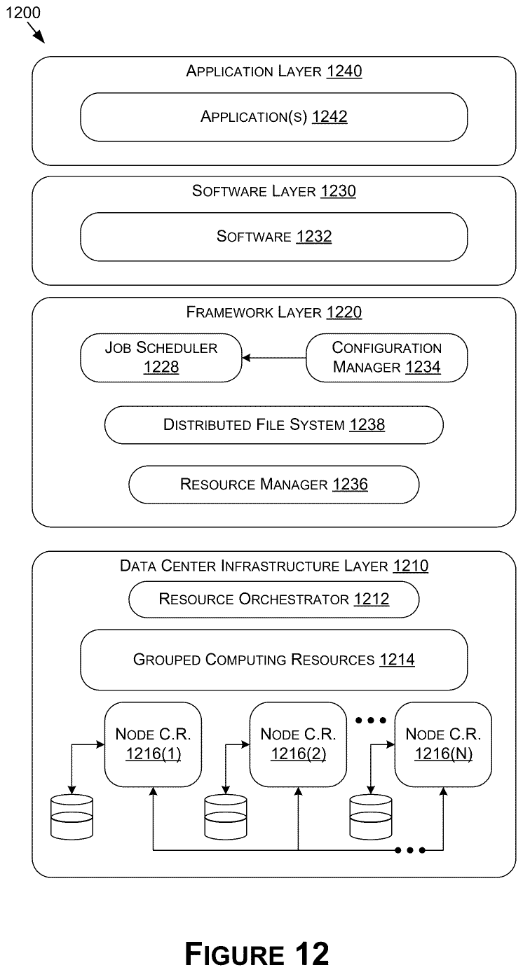

With reference to FIG. 1, FIG. 1 is an example robotics development system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 10A-10C), one or more computing devices or components thereof (e.g., as described in FIG. 11), and/or one or more data centers or components thereof (e.g., as described in FIG. 12).

Generally, the robotics development system 100 may comprise a network of nodes (which, as with other components described herein, may include similar components, features, and/or functionality to the example computing device 1100 of FIG. 11) that host any type and number of services that implement, facilitate, and/or otherwise support training and/or testing of humanoid robots, physical AI, or other AI systems and applications, such as reinforcement learning, imitation learning, supervised learning, hardware-in-the-loop testing or validation, robot simulation, synthetic data generation, data scraping, data management and storage, and/or distributing computing, to name a few examples. The robotics development system 100 may be hosted in one or more data centers (e.g., the data center 1200 of FIG. 12), and the illustrated portion of robotics development system 100 may represent some portion (e.g., a cluster of nodes) of a larger distributed computing environment. Although FIG. 1 is described as involving a foundation model 170 for a robotics application (such as the generative language models described in FIGS. 10A-10C), this is not intended to be limiting, and those of ordinary skill in the art will understand how to adapt the techniques described herein for other types of neural networks (e.g., language model(s) such as LLM(s), VLM(s), or MMLM(s), foundation model(s), etc.) and other machine learning models.

In high level overview, a developer may use a client device 105 to interface with an orchestration tool 115 (e.g., NVIDIA OSMO) to specify a (e.g., training or testing) workflow 110 for an application such as a robotics application, the orchestration tool 115 may decompose the workflow 110 into corresponding tasks such as synthetic data generation, data scraping, reinforcement learning, supervised learning, hardware-in-the-loop testing or validation, and/or others, and the orchestration tool 115 may delegate the tasks to corresponding clusters and/or data centers for execution. In some embodiments, supported services or functions may be prepackaged into containers stored in a container registry 160, the orchestration tool 115 may identify which containers are used in the specified workflow 110 and inform the assigned clusters and/or data centers which tasks they are responsible for executing or which container to load, and the assigned clusters and/or data centers may load a corresponding container from the container registry 160. FIG. 1 illustrates an example workflow 110 in which a (e.g., robotics) foundation model 170 is trained using reinforcement learning and supervised learning. More specifically, in this example, the orchestration tool 115 may schedule and instruct one or more simulation clusters 140 to generate skills or experiences 145 (e.g., by training the foundation model 170 using reinforcement learning in a simulation such as NVIDIA Isaac Sim, using simulation assets 130 that define a 3D scene, using robot data 135 that model the robot or define interactions with the simulation), and may schedule and instruct one or more training clusters 150 to generate model updates 155 (e.g., by training the foundation model 170 using supervised learning). The robotics development system 100 may operate the reinforcement learning and supervised learning (e.g., sequentially, concurrently) in a loop or cyclic workflow, storing the model updates 155 and skills or experiences 145 in a data store 120, such that the simulation cluster(s) 140 may use the latest version of the foundation model 170 and the training cluster(s) 150 may sample from the latest learned skills or experiences from the data store 120.

Generally, the orchestration tool 115 may use any known technique to accept input specifying the workflow 110, decompose the workflow 110 into corresponding tasks or jobs, and orchestrate or schedule execution of the tasks or jobs on corresponding clusters and/or data centers. In an example implementation, the orchestration tool 115 deploys (e.g., backend) agents within each cluster or data center that is part of its managed environment. As such, the agents may interface directly with its local cluster infrastructure. Upon deployment, each agent may automatically register itself with the orchestration tool 115, providing the orchestration tool 115 with a unified view of all available resources. As such, the orchestration tool 115 may effectively become the front-facing interface for users such as developers of robotics applications. For example, the orchestration tool 115 may function as an application programming interface (API) or service layer that abstracts the complexity of managing distributed resources and training or testing workflows. Developers may use any known technique to interact with this API to define, submit, and/or manage their training or testing workflows, without needing to interact directly with individual clusters or their underlying schedulers. As such, the orchestration tool 115 may decompose specified workflows into modular tasks or jobs, map them to and deploy them on the appropriate clusters (e.g., assigning certain tasks or jobs to clusters equipped with specialized hardware tailored for a corresponding task or job), and/or orchestrate execution of the entire workflow 110. This architecture simplifies the development process, allowing users to focus on application logic while the orchestration tool 115 handles resource allocation, scheduling, and/or coordination of task or job execution in the background. Example orchestration tools include NVIDIA OSMO, Slurm, and Run: AI.

In some embodiments, the orchestration tool 115 may delegate designated tasks or jobs to nodes or clusters equipped with specialized hardware tailored for the task or job. For example, the orchestration tool 115 may assign physics-based simulations for reinforcement learning or synthetic data generation jobs to nodes or clusters equipped with ray-tracing accelerators such as GPUs that have ray-tracing cores. In some embodiments, the orchestration tool 115 may assign supervised learning jobs to nodes or clusters equipped with AI or deep learning accelerators such as GPUs that have tensor cores. Additionally or alternatively, the orchestration tool 115 may assign hardware-in-the-loop testing or validation jobs to nodes or clusters equipped with edge accelerators such as GPUs with internal or external specialized cores optimized for efficient or low-power inference at the edge. These are just a few examples, and the orchestration tool 115 may assign other types of tasks or jobs to nodes or clusters equipped with specialized hardware.

In some embodiments, the orchestration tool 115 may instruct assigned clusters or data centers to execute an identified task or job in the workflow 110 by communicating with the backend agents deployed within corresponding clusters. The orchestration tool 115 may specify task instructions (e.g., defining what the assigned job or task entails, such as executing a specific script, running a containerized application, or performing a computation), resource requirements (e.g., specifying computational resources needed for the task, such as the number of CPUs, GPUs, memory, storage, or network bandwidth), runtime parameters (e.g., providing specific configurations or settings used during execution, such as input file paths, environment variables, or hyperparameters for training), and/or task dependencies (e.g., indicating tasks that should be completed before others can begin) via APIs, job queues, or other known techniques. In some embodiments, the robotics development system 100 hosts cloud applications or other cloud services using containers and/or containerized applications. Generally, containerization may involve encapsulating an application or a segment of an application (e.g., a microservice) along with its dependencies, libraries, and/or configuration files in a self-contained unit known as a container, which facilitates running the application or microservice consistently across different computing environments. Multiple containers may be deployed on a single host operating system on a node and/or virtual machine, and may share various resources such as processing resources (e.g., CPU, GPU), memory or storage resources (e.g., memory bandwidth), and/or networking resources. As such, the orchestration tool 115 may specify corresponding containers, and the backend agents may load (or instruct corresponding nodes to load) a specified container (e.g., a container image) from the container registry 160. In some embodiments, the backend agents translate the instructions into commands compatible with a local scheduler (e.g., Kubernetes, Slurm) to allocate resources and initiate execution. The orchestration tool 115 may provide a dashboard 190 (e.g., TensorBoard) that visualizes the progress, metrics, and/or controls for the workflow 110. For example, the dashboard 190 may aggregate and display metrics such as training accuracy, loss curves, resource utilization (e.g., GPU and memory usage), task statuses, and/or other metrics for each task or job in the workflow 110. As such, the dashboard 190 may provide a centralized view of distributed workloads across assigned clusters and/or data centers, making it easier to track progress, debug issues, and optimize performance.

Continuing with the example workflow 110 involving reinforcement and supervised learning illustrated in FIG. 1, the orchestration tool 115 may coordinate training multiple instances of the foundation model 170 in parallel using reinforcement and/or imitation learning in a simulation running on the simulation cluster(s) 140 (e.g., rendering nodes equipped with ray-tracing accelerators), training multiple instances of the foundation model 170 in parallel using supervised learning on the training cluster(s) 150 (e.g., AI nodes or deep learning nodes equipped with AI or deep learning accelerators), and may coordinate running the reinforcement/imitation learning and the supervised learning (e.g., sequentially, concurrently) in a loop or cyclic workflow.

More specifically, the orchestration tool 115 may coordinate training the foundation model 170 using reinforcement learning in a simulation (e.g., NVIDIA Isaac Sim) running on one or more simulation clusters 140 using simulation assets 130 that define a 3D scene and robot data 135 that model the robot or define interactions with the simulation. For example, a developer operating the client device 105 may interact with an interface (e.g., provided by the orchestration tool 115) to specify the foundation model 170 to be trained, the simulation environment (e.g., 3D scenes that arrange the simulation assets 130), the robot data 135 defining the robot model, the reinforcement learning algorithm (e.g., reward functions, hyperparameters, policy architectures), the supervised learning configuration (e.g., training data, hyperparameters, batch sizes, learning rates), resources to use for each task or job (e.g., the number and/or type of compute nodes to run on), and/or other characteristics. For example, the interface may accept input authoring the 3D scene with simulation assets 130 (e.g., specified or converted to a file format such as Universal Scene Description (OpenUSD)) using any known technique. The robot data 135 may comprise a model or other virtual representation of the physical structure, kinematics, dynamics, initial configuration, and/or other characteristics of an applicable robot (e.g., a humanoid robot, manipulator, quadruped, autonomous mobile robot, (AMR), or other type of robot) specified in any suitable format (e.g., the Unified Robot Description Format (URDF)); action or control commands the robot should execute during the simulation (e.g. movement commands such as joint rotations, velocities, or forces; high-level goals such as “move to [a specified position]”); learned skills or experiences from the data store 120 to apply during training; and/or otherwise.

As such, the orchestration tool 115 may deploy one or more reinforcement learning tasks or jobs on one or more corresponding (e.g., rendering) nodes in the simulation cluster(s) 140. For example, each node in the simulation cluster(s) 140 (or each set of nodes cooperating to run a particular reinforcement learning job in the simulation cluster(s) 140) may load the most recent version of the foundation model 170 from the data store 120 (e.g., multiple nodes may be used to run a given instance of the foundation model 170), may apply one or more specified and/or sampled skills or experiences stored in the data store 120 to the foundation model 170, may use the foundation model 170 to control a digital twin representing the robot and perform reinforcement learning in the simulation using the specified workflow 110 to generate new skills or experiences 145, and may store the new skills or experiences 145 in the data store 120. Furthermore, the orchestration tool 115 may deploy one or more supervised learning tasks or jobs on one or more corresponding (e.g., AI nodes or deep learning nodes) nodes in the training cluster(s) 150. For example, each node in the training cluster(s) 150 (or each set of nodes cooperating to run a particular supervised learning job in the training cluster(s) 150) may load the most recent version of the foundation model 170 from the data store 120, may apply one or more specified and/or sampled skills or experiences stored in the data store 120, may perform supervised learning using the specified workflow 110 to generate model updates 155 to the foundation model 170 (e.g., weights and/or gradients), and may store the model updates 155 in the data store 120. As such, the reinforcement and supervised learning jobs may run (e.g., sequentially or concurrently) in a loop or circular workflow in which the outputs of the reinforcement learning jobs are used as inputs to the supervised learning jobs, and vice versa.

In some embodiments, the reinforcement and supervised learning jobs may run concurrently in the loop or circular workflow, such that the reinforcement learning jobs continuously generate new skills or experiences 145, and the supervised learning jobs continuously generate new model updates 155, with new jobs sampling from the most recent set of data available in the data store 120. In some scenarios such as some embodiments in which the foundation model 170 is a robotics foundation model such as Project Gr00T, the supervised learning may take on the order of days, weeks, or even months. As such, an individual supervised learning job may periodically checkpoint its progress (e.g., in case the job crashes), periodically check the data store 120 for new data (e.g., additional skills or experiences 145, training data), and/or use any new data (e.g., applying additional skills or experiences 145, using additional training data) during execution of that job.

As such, the reinforcement learning and supervised learning may continuously improve the foundation model 170, which may constitute the robot brain in some embodiments involving a robotics foundation model. The example workflow 110 involving reinforcement and supervised learning is meant simply as an example, and other types of workflows may be orchestrated, such as those involving synthetic data generation, real data scraping or retrieval, supervised learning, reinforcement learning, imitation learning, hardware-in-the-loop testing or validation, and/or other tasks or jobs. For example, the orchestration tool 115 may coordinate training multiple instances of the foundation model 170 in parallel using supervised learning on the training cluster(s) 150 (e.g., AI nodes or deep learning nodes equipped with AI or deep learning accelerators) and generating synthetic training data for the foundation model 170 in multiple jobs running in parallel on the simulation cluster(s) 140. Additionally or alternatively, the orchestration tool 115 may coordinate hardware-in-the-loop testing or validation running multiple instances of at least a portion of a physical deployment of the applicable robot (e.g., including the latest version of the foundation model 170) on one or more robot clusters and multiple instances of a simulation controlling corresponding instances of a digital twin of the robot(s) running on the simulation cluster(s) 140.

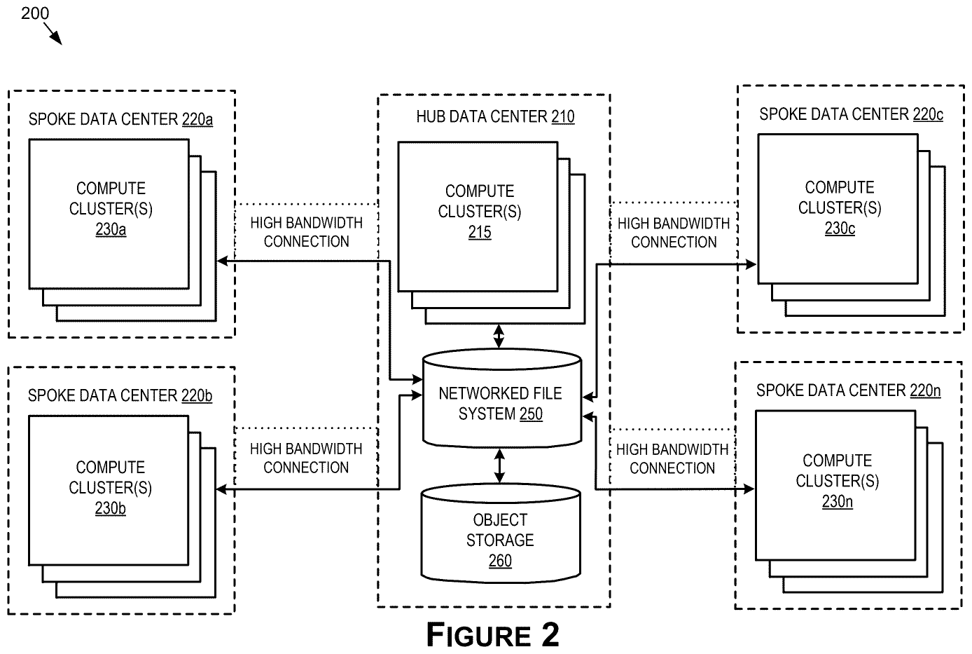

FIG. 2 is a block diagram of an example distributed infrastructure 200 which may be used to implement some embodiments of the present disclosure. In the example illustrated in FIG. 2, the distributed infrastructure 200 includes a hub data center 210 with compute cluster(s) 215 and spoke data centers 220a-n with corresponding compute cluster(s) 230a-n in a hub-and-spoke model. The hub data center 210 and the spoke data centers 220a-n may be hosted by any number of cloud providers and may be connected to each other using high-bandwidth connections such as a direct interconnect or dedicated private link offered by various cloud providers (e.g., MICROSOFT AZURE® EXPRESSROUTE®, AMAZON WEB SERVICES® Direct Connect, GOOGLE® Cloud Interconnect). Since cloud providers typically avoid placing different types of compute nodes in the same cluster, the compute cluster(s) 215 and/or 230a-n may include different types of compute clusters composed with different types of compute nodes. In an example embodiment, each of the spoke data centers 220a-n includes one or more corresponding compute clusters (e.g., the compute cluster(s) 230a-n), and the hub data center 210 includes zero or more compute clusters (e.g., the compute cluster(s) 215). Although the configuration illustrated in FIG. 2 spans multiple data centers, this need not be the case, and some or all of the compute cluster(s) 230a-n may be hosted within the hub data center 210 (in which case, connections to the networked file system 250 may be implemented without a direct interconnect or dedicated private link).

In FIG. 2, the hub data center 210 includes a (e.g., fast-tier) networked file system 250 that (e.g., all) the compute nodes in (e.g., all) the clusters and data centers may access, and (e.g., a slow-tier) object storage 260 which may be scaled as large as needed for a specified workflow (e.g., the workflow 110 of FIG. 1). The compute cluster(s) 215 of the hub data center 210 may include one or more nodes (e.g., one or more CPU nodes, whether part of a dedicated cluster with only CPU nodes or a mixed cluster with one or more specialized nodes such as training nodes and one or more CPU nodes; one or more specialized nodes that are not occupied with other tasks or jobs, etc.) that monitor the data in the networked file system 250 and back up data that is not used (e.g., data that has not been used for a designated duration of time, data that has been used least recently, etc.), for example, by reading it from the networked file system 250 and writing it to the object storage 260. The node(s) may receive instructions (e.g., from the orchestration tool 115 of FIG. 1) identifying data needed for a specified workflow, job, or task. For example, the data in the networked file system 250 and/or the object storage 260 may be indexed in any suitable way (e.g., by dataset identifier, data type, content tags, creation date, etc.) such that a training or testing workflow may use the indexing scheme to specify the type of (e.g., training) data to use for that workflow (e.g., training data for a designated task or environment, such as perceiving objects in a kitchen or at night, recognizing human speech commands, detecting obstacles in indoor navigation, classifying human gestures, identifying tools for manipulation tasks, mimicking human-like motion such as walking or grasping, etc.). As such, in response to identifying data needed for a specified workflow, job, or task, the node(s) may inspect the networked file system 250 to determine whether the data is available in the networked file system 250 and/or may retrieve matching data from the object storage 260 and write it to the networked file system 250. In some embodiments, an interface (e.g., provided by the orchestration tool 115 of FIG. 1) may accept input manually browsing and moving data between the networked file system 250 and the object storage 260. These are meant simply as examples, and variations may be implemented within the scope of the present disclosure.

As such, all compute clusters across all data centers may communicate with each other by reading and/or writing data to the networked file system 250, eliminating the need for direct cluster-to-cluster communication and corresponding complex routing configurations while delivering high performance. A two-tiered storage system with a relatively fast but small networked file system 250 and a relatively slow but large object storage 260 provides the benefits of both a high-throughput networked file system and the large capacity of object storage. The following figures represent example use cases which may be implemented using the distributed infrastructure 200 of FIG. 2.

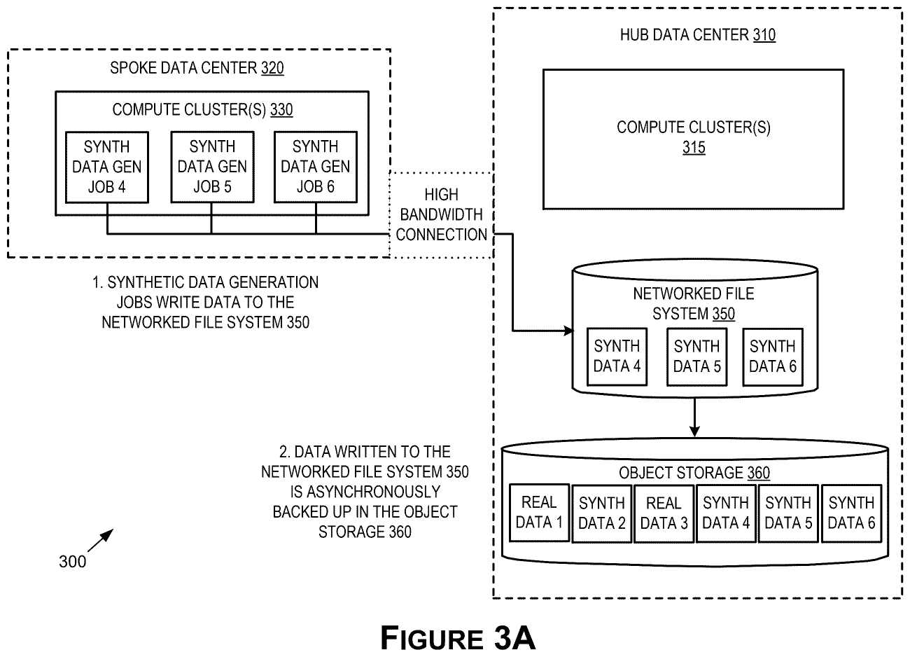

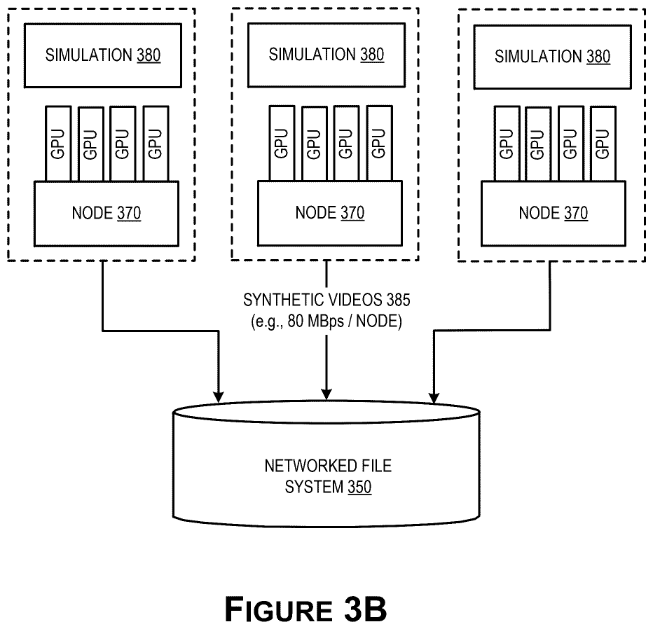

FIGS. 3A and 3B are block diagrams of an example distributed infrastructure 300 for synthetic data generation, in accordance with some embodiments of the present disclosure. In FIG. 3A, the distributed infrastructure 300 includes a hub data center 310 (which may correspond to the hub data center 210 of FIG. 2) comprising compute cluster(s) 315 (which may correspond to the compute cluster(s) 215 of FIG. 2), a networked file system 350 (which may correspond to the networked file system 250 of FIG. 2), and object storage 360 (which may correspond to the object storage 260 of FIG. 2), and a spoke data center 320 (which may correspond to one or more of the spoke data centers 220a-n of FIG. 2) comprising compute cluster(s) 330 (which may correspond to the compute cluster(s) 230a-n of FIG. 2). In this example, the compute cluster(s) 330 running in the spoke data center 320 may execute various synthetic data generation jobs (e.g., in parallel). Each synthetic data generation job may run a corresponding instance of a simulation environment (e.g., NVIDIA Isaac Sim) on a corresponding node in the compute cluster(s) 330 using any known technique to generate synthetic data. As such, each synthetic data generation job may transmit the resulting synthetic data (e.g., synthetic videos) to the networked file system 350, and the synthetic data may be (e.g., asynchronously) backed up to the object storage 360 (e.g., in a training dataset comprising other synthetic data and/or real data).

FIG. 3B illustrates an example implementation of this workflow in which multiple instances of a simulation 380 (e.g., NVIDIA Isaac Sim) are run (e.g., in parallel) on corresponding nodes 370 of the compute cluster(s) 330 of FIG. 3A (e.g., rendering nodes equipped with ray-tracing accelerators, such as NVIDIA OVX nodes with L40 GPUs) to generate corresponding synthetic videos 385. In this example, the various instances of the simulation 380 need not communicate with another. As such, each node 370 may store a corresponding synthetic video 385 in the networked file system 350 (e.g., a 2 petabyte (PB) LUSTRE® drive). By way of nonlimiting example, each GPU may produce a 10-megabyte (MB) video per second, and each node 370 may include 8 GPUs such that each node 370 generates a total of 80MB of video per second. Rounding up to provide margin for future growth, the networked file system 350 may be configured to support a write throughput of 100 megabytes per second (MBps).

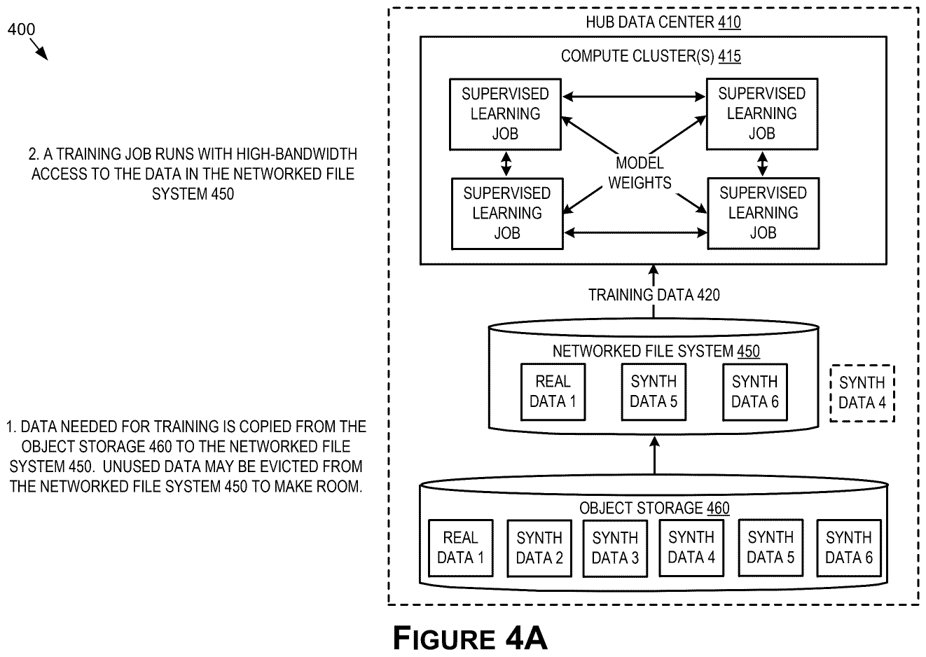

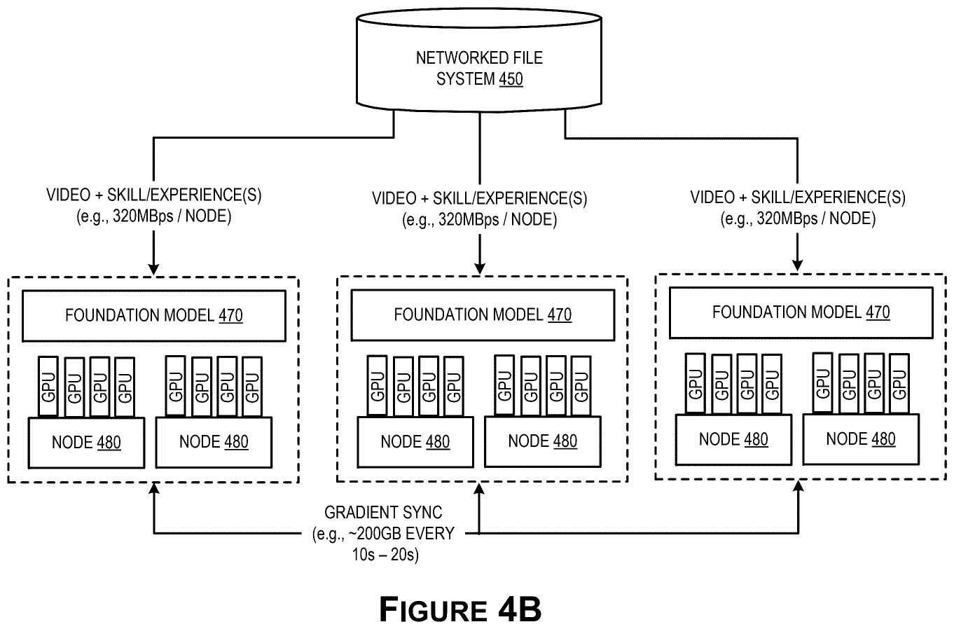

FIGS. 4A and 4B are block diagrams of an example distributed infrastructure 400 for supervised learning, in accordance with some embodiments of the present disclosure. In FIG. 4A, the distributed infrastructure 400 includes a hub data center 410 (which may correspond to the hub data center 210 of FIG. 2 and/or the hub data center 310 of FIG. 3) comprising compute cluster(s) 415 (which may correspond to the compute cluster(s) 215 of FIG. 2 and/or the compute cluster(s) 315 of FIG. 3), a networked file system 450 (which may correspond to the networked file system 250 of FIG. 2 and/or the networked file system 350 of FIG. 3), and object storage 460 (which may correspond to the object storage 260 of FIG. 2 and/or the object storage 360 of FIG. 3). In this example, the compute cluster(s) 415 running in the hub data center 410 execute various supervised learning jobs (e.g., in parallel). Each supervised learning job may retrieve and/or sample the training data 420 from the networked file system 450 (e.g., real and/or synthetic data, such as the synthetic videos 385 of FIG. 3B), retrieve the latest version of a machine learning model (e.g., the foundation model 170 of FIG. 1) from the networked file system 450, sample and apply one or more learned skills or experiences (e.g., the skills or experiences 145 of FIG. 1) from the networked file system 450 to the machine learning model, and use the training data 420 to train a corresponding instance of the machine learning model on any number of nodes the compute cluster(s) 415 using any known technique. In some embodiments, concurrently executing supervised learning jobs may periodically synchronize model updates (e.g., weights, gradients, etc.). As such, each supervised learning job may store the resulting model update in the networked file system 450 (e.g., as part of the model updates 155 of FIG. 1), and the model updates may be (e.g., asynchronously) backed up to the object storage 460.

One of the benefits of storing model updates in the networked file system 450 is that it facilitates checkpointing to mitigate against crashes. Some supervised learning jobs may take hours, days, or longer, so the supervised learning jobs may periodically save checkpoints to the networked file system 450 during execution of a given job. This way, if a supervised learning job crashes hours or even days into the job, the most recent checkpoint may be retrieved from the networked file system 450 so the previous training should not be lost. When the supervised learning job is finished, it may instruct the node(s) responsible for managing data in the networked file system 450 and/or the object storage 460 to copy the completed model update (e.g., a set of weights and/or gradients) from the networked file system 450 to the object storage 460.

FIG. 4B illustrates an example implementation of this workflow in which multiple instances of a foundation model 470 (e.g., Project Gr00T) are trained (e.g., in parallel) on corresponding nodes 480 of the compute cluster(s) 415 of FIG. 4A (e.g., AI nodes or deep learning nodes equipped with AI or deep learning accelerators, such as NVIDIA DGX nodes with H100 GPUs, or other types of nodes such as rendering nodes equipped with ray-tracing accelerators, for example, if there are not enough AI or deep learning accelerators available in the cluster(s) 415) to generate corresponding model updates. In this example, the node(s) 480 running a corresponding supervised learning job may sample training data (e.g., videos) and/or learned skills or experiences, may periodically check the networked file system 450 for new training data and/or learned skills or experiences, and may switch to using new training data (e.g., using newly generated videos such as the synthetic videos 385 of FIG. 3B for subsequent training iterations during the job) or new learned skills or experiences (e.g., applying one or more newly learned skills or experiences to the model being trained during the job). Depending on the implementation and/or model being trained, multiple nodes 480 may be used to train an instance of the model in a single supervised learning job, and the nodes 480 running different supervised learning jobs may periodically synchronize model updates (e.g., weights and/or gradients). As such, the node(s) 480 implementing each supervised learning job may store a corresponding model update in the networked file system 450 (e.g., a 2 PB LUSTRE drive). By way of nonlimiting example, each GPU may consume 16 video clips per second, each video clip may be approximately 10 seconds long with a resolution of 1280×720, a frame rate of 30 frames per second, and compressed using the H.264 video codec, resulting in a bit rate of 2 megabits per second (Mbps). If each node 480 includes 8 GPUs, each node 480 may utilize a bandwidth of 16*10*2*8 =2560Mbps (320 MBps).

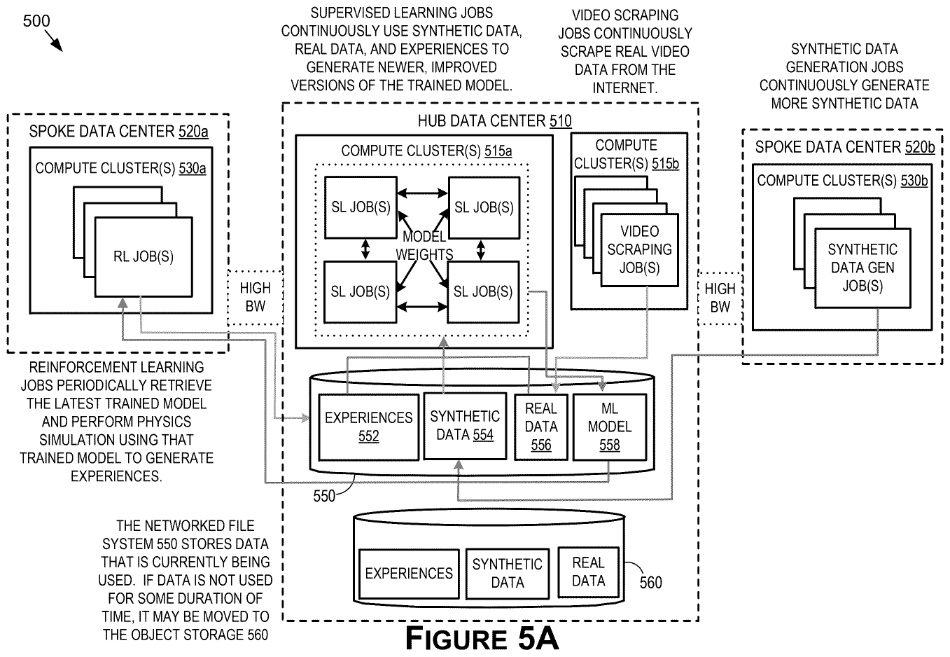

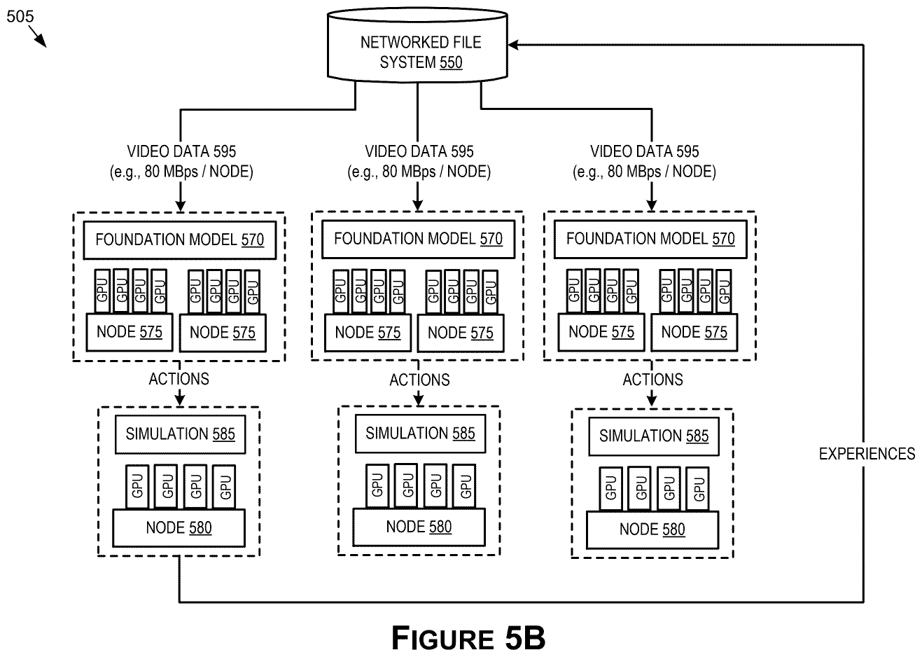

FIGS. 5A and 5B are block diagrams of an example distributed infrastructure 500 with circular workflows, in accordance with some embodiments of the present disclosure. In FIG. 5A, the distributed infrastructure 500 includes a hub data center 510 (which may correspond to the hub data center 210 of FIG. 2, the hub data center 310 of FIG. 3, and/or the hub data center 410 of FIG. 4) comprising compute cluster(s) 515a and 515b (which may correspond to the compute cluster(s) 215 of FIG. 2, the compute cluster(s) 315 of FIG. 3, and/or the compute cluster(s) 415 of FIG. 4), a networked file system 550 (which may correspond to the networked file system 250 of FIG. 2, the networked file system 350 of FIG. 3, and/or the networked file system 450 of FIG. 4), and object storage 560 (which may correspond to the object storage 260 of FIG. 2, the object storage 360 of FIG. 3, and/or the object storage 460 of FIG. 4). Moreover, the distributed infrastructure 500 illustrated in FIG. 5A includes a spoke data center 520a (which may correspond to one or more of the spoke data centers 220a-n of FIG. 2 and/or the spoke data center 320 of FIG. 3A) with compute cluster(s) 530a (which may correspond to the compute cluster(s) 230a-n of FIG. 2) and a spoke data center 520b (which may correspond to one or more of the spoke data centers 220a-n of FIG. 2 and/or the spoke data center 320 of FIG. 3A) with compute cluster(s) 530b (which may correspond to the compute cluster(s) 230a-n of FIG. 2 and/or the compute cluster(s) 330 of FIG. 3A).

In this example, the compute cluster(s) 515a (e.g., training cluster(s)) in the hub data center 510 may run one or more supervised learning jobs that train corresponding instances of a machine learning model 558 such as the foundation model 170 of FIG. 1 (e.g., in parallel) using synthetic data 554 (e.g., synthetic videos) generated by multiple synthetic data generation jobs running corresponding instances of a simulation environment such as NVIDIA Isaac Sim (e.g., in parallel) in the compute cluster(s) 530b (e.g., simulation cluster(s)) in the spoke data center 520b. Each of the synthetic data generation jobs may generate corresponding synthetic data 554 (e.g., one or more corresponding videos), write the synthetic data 554 to the networked file system 550, and trigger one or more nodes in the hub data center 510 responsible for data management to (e.g., asynchronously) backup the synthetic data 554 to the object storage 560. Additionally or alternatively, the compute cluster(s) 515b (e.g., CPU cluster(s)) in the hub data center 510 may run video (or other types of data) scraping jobs (e.g., in parallel) using any known technique, write the resulting real data 556 in the networked file system 550, and trigger one or more nodes in the hub data center 510 responsible for data management to (e.g., asynchronously) backup the real data 556 to the object storage 560. As such, the node(s) responsible for data management may receive instructions (e.g., from the orchestration tool 115 of FIG. 1) identifying data needed for a specified workflow, job, or task, determine whether the data is available in the networked file system 550, and/or retrieve matching data from the object storage 560 and write it to the networked file system 550.

As such, the supervised learning job(s) running on the compute cluster(s) 515a may retrieve and/or sample training data (e.g., the synthetic data 554 and/or the real data 556) from the networked file system 550, may retrieve the latest version of the machine learning model 558 from the networked file system 550, may sample and apply one or more learned skills or experiences 552 (e.g., the skills or experiences 145 of FIG. 1) from the networked file system 550 to the machine learning model 558, and may use the training data to train a corresponding instance of the machine learning model 558 on any number of nodes the compute cluster(s) 515a using any known technique. In some embodiments, the supervised learning job(s) running in the compute cluster(s) 515a, the video scraping job(s) running in the compute cluster(s) 515b, and/or the synthetic data generation job(s) running in the compute cluster(s) 530b may run in parallel, continuously generating and training with new videos in a loop or circular workflow.

Note the data centers in which the supervised learning, video scraping, and synthetic data generation job(s) are illustrated as running represent one possible configuration, and other configurations are possible. For example, the supervised learning job(s) may run in (e.g., training) clusters in the hub data center 510 and/or one or more of the spoke data centers 520a and 520b, the video scraping job(s) may run in (e.g., CPU) clusters in the hub data center 510 and/or one or more of the spoke data centers 520a and 520b, and the synthetic data job(s) may run in (e.g., simulation) clusters in the hub data center 510 and/or one or more of the spoke data centers 520a and 520b. In some embodiments, the supervised learning job(s) may exclusively use the synthetic data 554 as training data, and may additionally or alternatively use the real data 556 as training data. In some cases, the supervised learning job(s) may exclusively use synthetic data 554 in the first few iterations and may incorporate more and more real data 556 with each successive iteration. These are just a few examples, and other variations may be implemented within the scope of the present disclosure.

Additionally or alternatively, the compute cluster(s) 530a (e.g., simulation cluster(s)) in the spoke data center 550a may run one or more reinforcement learning jobs that train corresponding instances of the latest version of the machine learning model 558 (e.g., in parallel) using corresponding instances of a simulation environment (e.g., NVIDIA Isaac Sim) to generate and store new learned skills or experiences 552 in the networked file system 550. As such, the compute cluster(s) 515a (e.g., training cluster(s)) in the hub data center 510 may run one or more supervised learning jobs that train corresponding instances of the machine learning model 558 (e.g., in parallel) using the learned skills or experiences 552 to generate improved versions of the machine learning model 558. The supervised learning job(s) running on the compute cluster(s) 515a may retrieve and/or sample training data (e.g., the synthetic data 554 and/or the real data 556) from the networked file system 550, may retrieve the latest version of the machine learning model 558 from the networked file system 550, may sample and apply one or more learned skills or experiences 552 from the networked file system 550 to the machine learning model 558, may use supervised learning to generate improved version(s) of the machine learning model 558, and may store a representation of the improved version(s) of the machine learning model 558 in the networked file system 550.

As such, the reinforcement learning job(s) that run corresponding simulations in the compute cluster(s) 530a in the spoke data center 550a may retrieve the latest version of the machine learning model 558, simulation assets (e.g., the simulation assets 130 of FIG. 1) that define a 3D scene, and data modeling an agent to control in the simulation (e.g., robot data such as the robot data 135 of FIG. 1 in embodiments involving robots) from the networked file system 550, construct corresponding input data (e.g., video of a demonstration or instructions to guide initial learning, simulated visual inputs representing a simulated environment during training), apply the input data to corresponding instances of the latest version of the machine learning model 558 to determine actions for the agent to perform, apply the actions to a corresponding digital twin in the corresponding instance of the simulated environment to generate a reward signal based on the agent's performance, use the reward signal to update a corresponding instance of the machine learning model 558 and adjust its policy, generate a representation of the corresponding learned skill or experience (e.g., a set of deltas to the model weights), and store the learned skills or experiences as part of the learned skills or experiences 552 in the networked file system 550. In some embodiments, the reinforcement learning job(s) running in the compute cluster(s) 530a, the supervised learning job(s) running in the compute cluster(s) 515a, and/or the video scraping job(s) running in the compute cluster(s) 515b may run in parallel, continuously generating improved versions of the machine learning model 558, using the improved versions to generate learned skills or experiences 552, and using the learned skills or experiences 552 to generate improved versions of the machine learning model 558 in a loop or circular workflow.

FIG. 5B illustrates an example implementation of reinforcement learning in which multiple instances of a foundation model 570 (e.g., Project Gr00T) are trained (e.g., in parallel) using corresponding nodes 575 and 580 of the compute cluster(s) 530a of FIG. 5A (e.g., simulation nodes equipped with ray-tracing accelerators, such as NVIDIA OVX nodes with L40 GPUs) using video demonstrations (e.g., video data 595) retrieved from the networked file system 550. In this example, the node(s) 575 may use the video data 595 to conduct imitation learning on a corresponding instance of the foundation model 570 running on the node(s) 575 during an initial phase, training the model to mimic demonstrated behavior. Additionally or alternatively, the node(s) 575 may interface with a corresponding instance of the simulation 585 running on the node(s) 580 to apply visual data representing the simulated environment as input to a corresponding instance of the foundation model 570 running on the node(s) 575 to determine actions for a corresponding digital twin to take, and send the actions to the node(s) 580 running corresponding instances of the simulation 585. As such, the node(s) 580 may apply the actions to the digital twin in a corresponding instance of the simulation 585 running on the node(s) 580, coordinate with the nodes 575 to update the foundation model 570 based on a designated reward signal generated from the digital twin's performance in the simulation, and write the skills or experiences to the networked file system 550. In this example, the various instances of the simulation 585 need not communicate with another. Depending on the implementation and/or model being used, multiple nodes 575 may be used to run a single instance of the foundation model 570. By way of nonlimiting example, each GPU may consume a 10 MB video per second, and each node 575 may include 8 GPUs such that each node 575 consumes a total of 80 MB of video per second. Rounding up to provide margin for future growth, the networked file system 550 may be configured to support a read throughput of 100 MBps.

Returning to FIG. 5A, the data centers in which the reinforcement learning, supervised learning, and video scraping job(s) are illustrated as running in FIG. 5A represent one possible configuration, and other configurations are possible. For example, the reinforcement learning job(s) may run in (e.g., simulation) clusters in the hub data center 510 and/or one or more of the spoke data centers 520a and 520b, the supervised learning job(s) may run in (e.g., training) clusters in the hub data center 510 and/or one or more of the spoke data centers 520a and 520b, and/or the video scraping job(s) may run in (e.g., CPU) clusters in the hub data center 510 and/or one or more of the spoke data centers 520a and 520b. For example, the reinforcement learning job(s) may run in the hub data center 510, and the supervised learning job(s) may run in one or more of the spoke data centers 520a and 520b. In some embodiments, additionally or alternatively to using skills or experiences 552 generated by the reinforcement learning jobs, the supervised learning job(s) may use the synthetic data 554 and/or the real data 556 as training data. In some cases, the first few iterations of the supervised learning job(s) may use exclusively synthetic data 554 and may incorporate more and more real data 556 with each successive iteration. These are just a few examples, and other variations may be implemented within the scope of the present disclosure.

In some embodiments, the reinforcement learning job(s) (e.g., running in the compute cluster(s) 530a) and the synthetic data generation job(s) (e.g., running in the compute cluster(s) 530b) may run in parallel, continuously generating learned skills or experiences 552 and synthetic data 554. The reinforcement learning job(s) and the synthetic data generation job(s) may both run in simulation cluster(s) with the same type of node (e.g., ray-tracing accelerators such as NVIDIA OVX nodes with L40 GPUs). In some embodiments, all the reinforcement learning jobs may run in one set of cluster(s) and all the synthetic data generation job(s) may run in a separate set of cluster(s). In some embodiments, there may be some overlap such that some or all of the simulation clusters may be used to run both reinforcement learning and synthetic data generation jobs.

Another possible loop or circular workflow which may be implemented using the distributed infrastructure 200 of FIG. 2, the distributed infrastructure 300 of FIG. 3A, the distributed infrastructure 400 of FIG. 4A, and/or the distributed infrastructure 500 of FIG. 5A includes hardware-in-the-loop testing or validation with simulation interleaved with supervised and/or reinforcement learning. For example, taking the distributed infrastructure 200 of FIG. 2 as an example, one or more robot clusters (e.g., the compute cluster(s) 215 running in the hub data center 210 and/or the one or more of the compute cluster(s) 230a-n running in one or more of the spoke data centers 220a-n) may run testing or validation job(s) using corresponding instances of at least a portion of a physical deployment of a robot (including a corresponding foundation model, such as the foundation model 170 of FIG. 1). The robot cluster(s) may be in communication with one or more simulation clusters (e.g., the compute cluster(s) 215 running in the hub data center 210 and/or the one or more of the compute cluster(s) 230a-n running in one or more of the spoke data centers 220a-n) running corresponding instances of a simulation environment (e.g., NVIDIA Isaac Sim). Each of the instances of the simulation environment may render virtual sensor data, which may be transmitted to a corresponding robot. As such, the virtual sensor data may be applied to a corresponding robot in the robot cluster(s) to generate a corresponding action (e.g., actuation signals), which may be sent back to a corresponding instance of the simulation environment and used to control a corresponding digital twin of the robot, update the simulation, and generate updated virtual sensor data, and the process may repeat in a loop.

In some embodiments, the testing or validation job(s) and the supervised learning job(s) may run in parallel, continuously generating improved versions of the foundation model, and using the improved versions for hardware-in-the-loop testing or validation. These are just a few examples, and the distributed infrastructure 200 of FIG. 2 may be used to implement other types of workflows that rely on fast data sharing and distributed computation across different types of compute nodes within the scope of the present disclosure.

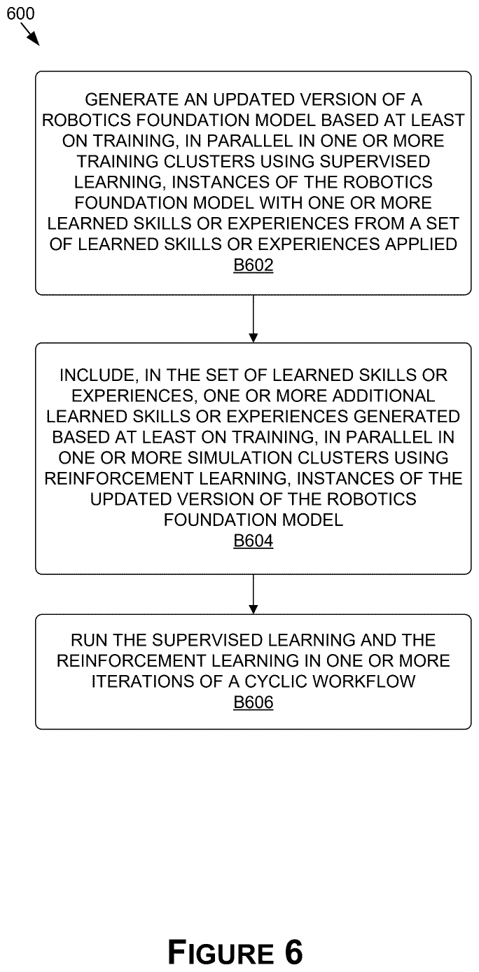

Now referring to FIGS. 6-9, each block of methods 600-900, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, the methods 600-900 are described, by way of example, with respect to the robotics development system 100 of FIG. 1, the distributed infrastructure 300 of FIG. 3A, the distributed infrastructure 400 of FIG. 4A, and/or the distributed infrastructure 500 of FIG. 5A. However, the methods may additionally or alternatively be executed by any one system, or any combination of systems, including, but not limited to, those described herein.

FIG. 6 is a flow diagram illustrating a method 600 for running supervised learning and reinforcement learning in a cyclic workflow, in accordance with some embodiments of the present disclosure. The method 600, at block B602, includes generating an updated version of a robotics foundation model based at least on training, in parallel in one or more training clusters using supervised learning, instances of the robotics foundation model with one or more learned skills or experiences from a set of learned skills or experiences applied. For example, with respect to the robotics development system 100 of FIG. 1, the orchestration tool 115 may schedule and instruct the one or more training clusters 150 to generate model updates 155 (e.g., by training the foundation model 170 using supervised learning). For example, each node in the training cluster(s) 150 (or each set of nodes cooperating to run a particular supervised learning job in the training cluster(s) 150) may load the most recent version of the foundation model 170 from the data store 120, may apply one or more specified and/or sampled skills or experiences stored in the data store 120, may perform supervised learning using the specified workflow 110 to generate model updates 155 to the foundation model 170 (e.g., weights and/or gradients), and may store the model updates 155 in the data store 120.

With respect to the distributed infrastructure 400 of FIG. 4, the compute cluster(s) 415 running in the hub data center 410 may execute various supervised learning jobs (e.g., in parallel). Each supervised learning job may retrieve and/or sample the training data 420 from the networked file system 450 (e.g., real and/or synthetic data, such as the synthetic videos 385 of FIG. 3B), retrieve the latest version of a machine learning model (e.g., the foundation model 170 of FIG. 1) from the networked file system 450, sample and apply one or more learned skills or experiences (e.g., the skills or experiences 145 of FIG. 1) from the networked file system 450 to the machine learning model, and use the training data 420 to train a corresponding instance of the machine learning model on any number of nodes the compute cluster(s) 415 using any known technique. With respect to the distributed infrastructure 500 of FIG. 5, the compute cluster(s) 515a (e.g., training cluster(s)) in the hub data center 510 may run one or more supervised learning jobs that train corresponding instances of a machine learning model 558 such as the foundation model 170 of FIG. 1 (e.g., in parallel).

The method 600, at block B604, includes, in the set of learned skills or experiences, one or more additional learned skills or experiences generated based at least on training, in parallel in one or more simulation clusters using reinforcement learning, instances of the updated version of the robotics foundation model. For example, with respect to the robotics development system 100 of FIG. 1, the orchestration tool 115 may coordinate training multiple instances of the foundation model 170 using reinforcement and/or imitation learning in a simulation running on the simulation cluster(s) 140 (e.g., rendering nodes equipped with ray-tracing accelerators). With respect to the distributed infrastructure 500 of FIG. 5, the compute cluster(s) 530a (e.g., simulation cluster(s)) in the spoke data center 550a may run one or more reinforcement learning jobs that train corresponding instances of the latest version of the machine learning model 558 (e.g., in parallel) using corresponding instances of a simulation environment (e.g., NVIDIA Isaac Sim) to generate and store new learned skills or experiences 552 in the networked file system 550.

The method 600, at block B606, includes running the supervised learning and the reinforcement learning in one or more iterations of a cyclic workflow. For example, the robotics development system 100 of FIG. 1 may operate the reinforcement learning and supervised learning (e.g., sequentially, concurrently) in a loop or cyclic workflow, storing the model updates 155 and skills or experiences 145 in a data store 120, such that the simulation cluster(s) 140 may use the latest version of the foundation model 170 and the training cluster(s) 150 may sample from the latest learned skills or experiences from the data store 120. With respect to the distributed infrastructure 500 of FIG. 5, the reinforcement learning job(s) running in the compute cluster(s) 530a, the supervised learning job(s) running in the compute cluster(s) 515a, and/or the video scraping job(s) running in the compute cluster(s) 515b may run in parallel/concurrently, continuously generating improved versions of the machine learning model 558, using the improved versions to generate learned skills or experiences 552, and using the learned skills or experiences 552 to generate improved versions of the machine learning model 558 in a loop or circular workflow.

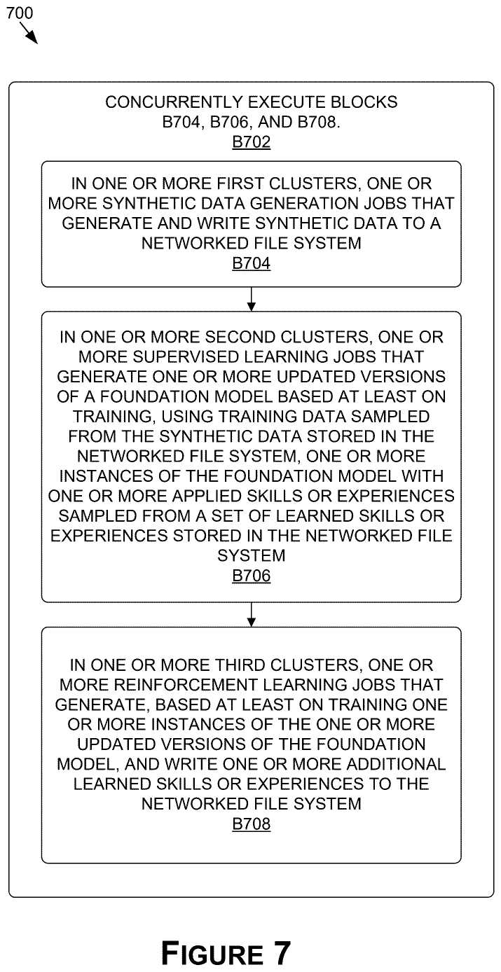

FIG. 7 is a flow diagram illustrating a method 700 for concurrently executing synthetic data generation, supervised learning, and reinforcement learning, in accordance with some embodiments of the present disclosure. The method 700, at block B702, includes concurrently executing blocks B704, B706, and B708. The method 700, at block B704, includes executing, in one or more first clusters, one or more synthetic data generation jobs that generate and write synthetic data to a networked file system. For example, with respect to the robotics development system 100 of FIG. 1, the orchestration tool 115 may coordinate generating synthetic training data for the foundation model 170 in multiple jobs running (e.g., sequentially, concurrently) on the simulation cluster(s) 140, and write the synthetic training data to the data store 120 (e.g., the networked file system 250 of FIG. 2).

The method 700, at block B706, includes executing, in one or more second clusters, one or more supervised learning jobs that generate one or more updated versions of a foundation model based at least on training, using training data sampled from the synthetic data stored in the networked file system, one or more instances of the foundation model with one or more applied skills or experiences sampled from a set of learned skills or experiences stored in the networked file system. For example, with respect to the robotics development system 100 of FIG. 1, the orchestration tool 115 may coordinate training multiple instances of the foundation model 170 (e.g., sequentially, concurrently) using supervised learning on the training cluster(s) 150 (e.g., AI nodes or deep learning nodes equipped with AI or deep learning accelerators). For example, each node in the training cluster(s) 150 (or each set of nodes cooperating to run a particular supervised learning job in the training cluster(s) 150) may load the most recent version of the foundation model 170 from the data store 120, may apply one or more specified and/or sampled skills or experiences stored in the data store 120 to the foundation model 170, my sample the synthetic training data (e.g., from the data store 120, from the networked file system 250 of FIG. 2), may perform supervised learning using the specified workflow 110 and sampled training data to generate model updates 155 to the foundation model 170 (e.g., weights and/or gradients), and may store the model updates 155 in the data store 120.

The method 700, at block B708, includes executing, in one or more third clusters, one or more reinforcement learning jobs that generate, based at least on training one or more instances of the one or more updated versions of the foundation model, and write one or more additional learned skills or experiences to the networked file system. For example, with respect to the robotics development system 100 of FIG. 1, the orchestration tool 115 may coordinate training the foundation model 170 using reinforcement learning in a simulation (e.g., NVIDIA Isaac Sim) running on the one or more simulation clusters 140. For example, each node in the simulation cluster(s) 140 (or each set of nodes cooperating to run a particular reinforcement learning job in the simulation cluster(s) 140) may load the most recent version of the foundation model 170 from the data store 120 (e.g., multiple nodes may be used to run a given instance of the foundation model 170), may apply one or more specified and/or sampled skills or experiences stored in the data store 120 to the foundation model 170, may use the foundation model 170 to control a digital twin representing the robot and perform reinforcement learning in the simulation using the specified workflow 110 to generate new skills or experiences 145, and may store the new skills or experiences 145 in the data store 120.

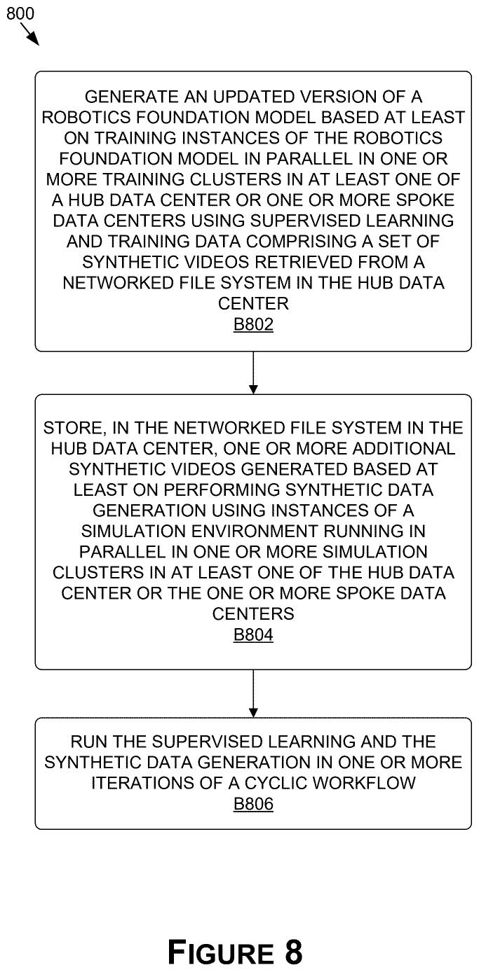

FIG. 8 is a flow diagram illustrating a method 800 for running supervised learning and synthetic data generation in at least one of a hub data center or one or more spoke data centers, in accordance with some embodiments of the present disclosure. The method 800, at block B802, includes generating an updated version of a robotics foundation model based at least on training instances of the robotics foundation model in parallel in one or more training clusters in at least one of a hub data center or one or more spoke data centers using supervised learning and training data comprising a set of synthetic videos retrieved from a networked file system in the hub data center. With respect to the distributed infrastructure 400 of FIG. 4, the compute cluster(s) 415 running in the hub data center 410 may execute various supervised learning jobs (e.g., in parallel). Each supervised learning job may retrieve and/or sample the training data 420 from the networked file system 450 (e.g., real and/or synthetic data, such as the synthetic videos 385 of FIG. 3B), retrieve the latest version of a machine learning model (e.g., the foundation model 170 of FIG. 1) from the networked file system 450, sample and apply one or more learned skills or experiences (e.g., the skills or experiences 145 of FIG. 1) from the networked file system 450 to the machine learning model, and use the training data 420 to train a corresponding instance of the machine learning model on any number of nodes the compute cluster(s) 415 using any known technique. With respect to the distributed infrastructure 500 of FIG. 5, the compute cluster(s) 515a (e.g., training cluster(s)) in the hub data center 510 may run one or more supervised learning jobs that train corresponding instances of a machine learning model 558 such as the foundation model 170 of FIG. 1 (e.g., in parallel).

The method 800, at block B804, includes storing, in the networked file system in the hub data center, one or more additional synthetic videos generated based at least on performing synthetic data generation using instances of a simulation environment running in parallel in one or more simulation clusters in at least one of the hub data center or the one or more spoke data centers. For example, with respect to the distributed infrastructure 300 of FIG. 3A, the compute cluster(s) 330 running in the spoke data center 320 may execute various synthetic data generation jobs (e.g., in parallel). Each synthetic data generation job may run a corresponding instance of a simulation environment (e.g., NVIDIA Isaac Sim) on a corresponding node in the compute cluster(s) 330 using any known technique to generate synthetic data. As such, each synthetic data generation job may transmit the resulting synthetic data (e.g., synthetic videos) to the networked file system 350, and the synthetic data may be (e.g., asynchronously) backed up to the object storage 360 (e.g., in a training dataset comprising other synthetic data and/or real data). With respect to the distributed infrastructure 500 of FIG. 5A, the compute cluster(s) 530b (e.g., simulation cluster(s)) in the spoke data center 520b may run corresponding synthetic data generation jobs in corresponding instances of a simulation environment and write the resulting synthetic data 554 to the networked file system 550.

The method 800, at block B806, includes running the supervised learning and the synthetic data generation in one or more iterations of a cyclic workflow. For example, with respect to the distributed infrastructure 500 of FIG. 5A, the supervised learning job(s) running in the compute cluster(s) 515a and the synthetic data generation job(s) running in the compute cluster(s) 530b may run (e.g., sequentially, concurrently/in parallel), continuously generating and training with new videos in a loop or circular workflow.

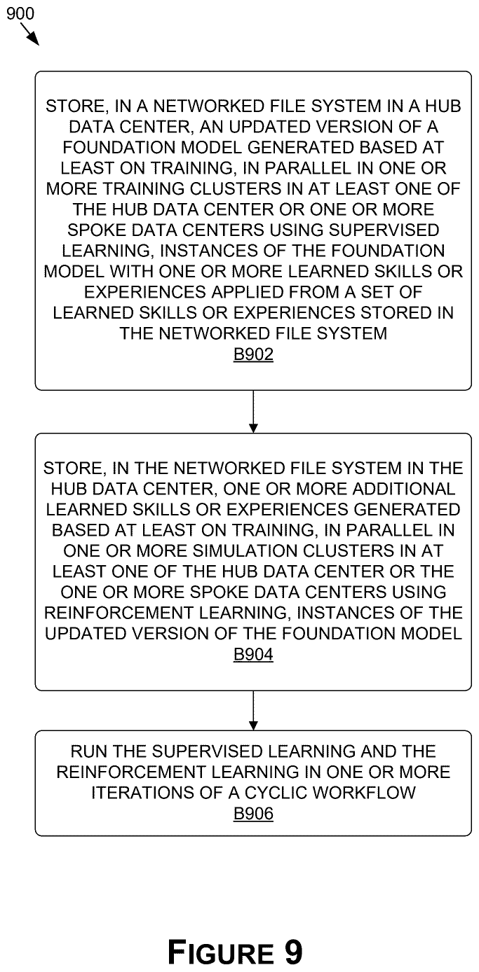

FIG. 9 is a flow diagram illustrating a method 900 for running supervised learning and reinforcement learning in at least one of a hub data center or one or more spoke data centers, in accordance with some embodiments of the present disclosure. The method 900, at block B902, includes storing, in a networked file system in a hub data center, an updated version of a foundation model generated based at least on training, in parallel in one or more training clusters in at least one of the hub data center or one or more spoke data centers using supervised learning, instances of the foundation model with one or more learned skills or experiences applied from a set of learned skills or experiences stored in the networked file system. For example, with respect to the distributed infrastructure 500 of FIG. 5, the compute cluster(s) 515a (e.g., training cluster(s)) in the hub data center 510 may run one or more supervised learning jobs that train corresponding instances of a machine learning model 558 such as the foundation model 170 of FIG. 1 (e.g., in parallel). For example, the supervised learning job(s) running on the compute cluster(s) 515a may retrieve and/or sample training data (e.g., the synthetic data 554 and/or the real data 556) from the networked file system 550, may retrieve the latest version of the machine learning model 558 from the networked file system 550, may sample and apply one or more learned skills or experiences 552 (e.g., the skills or experiences 145 of FIG. 1) from the networked file system 550 to the machine learning model 558, may use the training data to train a corresponding instance of the machine learning model 558 on any number of nodes the compute cluster(s) 515a using any known technique, and may write a representation of the updated version of the machine learning model 558 to the networked file system 550.

The method 900, at block B904, includes storing, in the networked file system in the hub data center, one or more additional learned skills or experiences generated based at least on training, in parallel in one or more simulation clusters in at least one of the hub data center or the one or more spoke data centers using reinforcement learning, instances of the updated version of the foundation model. For example, with respect to the distributed infrastructure 500 of FIG. 5A, the compute cluster(s) 530a (e.g., simulation cluster(s)) in the spoke data center 550a may run one or more reinforcement learning jobs that train corresponding instances of the latest version of the machine learning model 558 (e.g., in parallel) using corresponding instances of a simulation environment (e.g., NVIDIA Isaac Sim) to generate and store new learned skills or experiences 552 in the networked file system 550.

The method 900, at block B906, includes running the supervised learning and the reinforcement learning in one or more iterations of a cyclic workflow. For example, with respect to the distributed infrastructure 500 of FIG. 5A, the reinforcement learning job(s) running in the compute cluster(s) 530a and the supervised learning job(s) running in the compute cluster(s) 515a may run (e.g., sequentially, concurrently/in parallel), continuously generating improved versions of the machine learning model 558, using the improved versions to generate learned skills or experiences 552, and using the learned skills or experiences 552 to generate improved versions of the machine learning model 558 in a loop or circular workflow.

EXAMPLE APPLICATIONS

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some embodiments, the present techniques may be used to support a simulation. For example, a simulation may be used to create simulated datasets that replicate various real-world conditions (e.g., that may be difficult or dangerous to observe in the real world), and/or training or validating a neural network or classical machine learning model within a simulation may expose these models to a range of (e.g., rare or dangerous) scenarios in a controlled and safe environment. As such, in some embodiments, the systems and methods described herein may be performed within a simulation environment (e.g., NVIDIA's DriveSIM, NVIDIA's ISAAC GYM, NVIDIA's ISAAC SIM, etc.) using simulated data (e.g., simulated sensor data of simulated sensors of a virtual or simulated machine). For example, simulated sensor data may be used (e.g., processed using one or more machine learning models such as the foundation model 170 of FIG. 1) to perform the operations described herein, and may use this information to perform operations (e.g., control, navigation, planning, etc. operations) associated with a simulated machine or digital twin within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. In some embodiments, other methods may be used in addition or alternatively from a simulation to generate synthetic training data. For example, the synthetic training data may be generated using neural rendering fields (NERFs), Gaussian splat techniques, diffusion models, electrostatic models (e.g., Poisson flow generative models (PFGMs), etc. The synthetic training data (in addition to or alternatively from real-world data) may then be processed to determine geometry, curvature, semantic information, classification information, and/or other information related to features of interest, such as lines, longitudinal features (e.g., poles), and/or other features within a driving environment, a warehouse, etc., for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to train a model (e.g., the foundation model 170 of FIG. 1 or other machine learning models described herein) to identify (e.g., road) surface information that may be included in a visualization or mapping of an environment to aid a remote operator in controlling—or providing waypoints or other indications of control or navigation—an autonomous or semi-autonomous machine through an environment.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, foundation models, other machine learning models described herein, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, foundation models, other machine learning models described herein, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.), foundation models, other machine learning models described herein) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models such as the foundation model 170 of FIG. 1). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, foundation models, other machine learning models described herein, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) memory and/or storage (e.g., for storing control algorithms, sensor data, and one or more machine learning models), and memory and/or storage (e.g., for storing entertainment content, navigation data, and user preferences). The system may use these processors to execute one or more machine learning models (e.g., language models, foundation models, etc.) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

### EXAMPLE LANGUAGE MODELS

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof - may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively - for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof - and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### MACHINE LEARNING

Deep neural networks (DNNs) and other machine learning models have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system may be trained in object recognition and classification to identify objects and classify those objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features may be assigned a certain weight based on the importance of that feature in defining the shape of an object.

A DNN model typically includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer may assemble the lines to look for higher level patterns such as wheels, windshields, and mirrors. The next layer may identify a type of vehicle, and the final few layers may generate a label for the input image, identifying the model of a specific automobile brand.

Once the DNN is trained, it may be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label may be analyzed, and the weights may be adjusted for each feature during a backward propagation phase until the DNN correctly labels the input and other inputs in a training dataset. Training complex neural networks requires massive amounts of parallel computing performance, including floating-point multiplications and additions that may be supported by a parallel processing unit.

Whether during training, testing, or inference, neural networks rely heavily on matrix math operations, and complex multi-layered networks require tremendous amounts of floating-point performance and bandwidth for both efficiency and speed. In some embodiments (e.g., with thousands of processing cores, optimized for matrix math operations, delivering tens to hundreds of TFLOPS of performance), the parallel processing unit may be a computing platform capable of supporting deep neural network-based artificial intelligence and machine learning applications.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice - such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as foundation models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models.

### EXAMPLE COMPUTING DEVICE

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106) and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

EXAMPLE DATA CENTER

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R. s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R. s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark^{TM} (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### EXAMPLE AUTONOMOUS VEHICLE

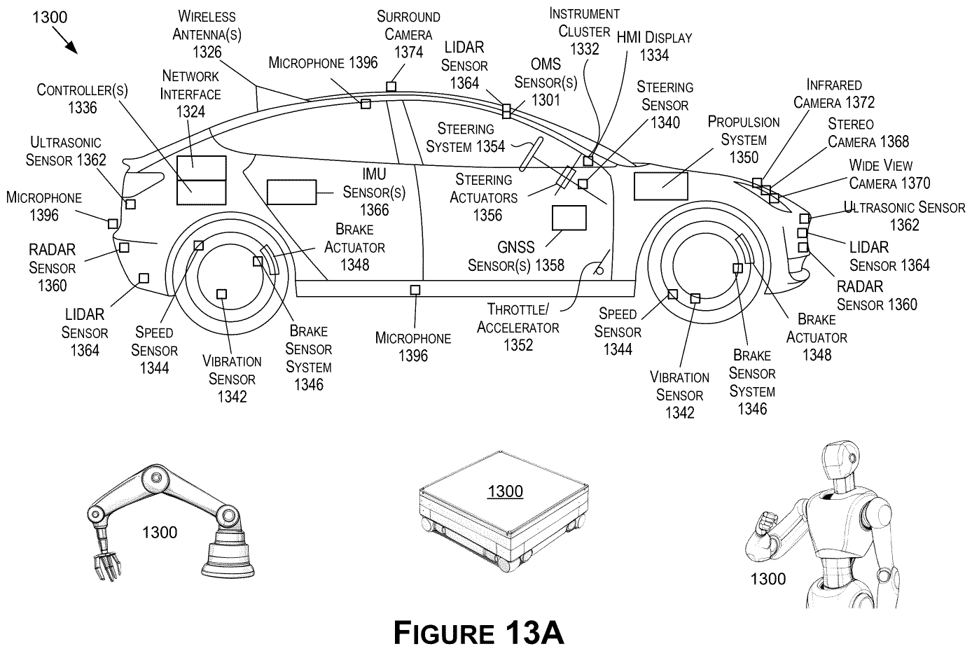

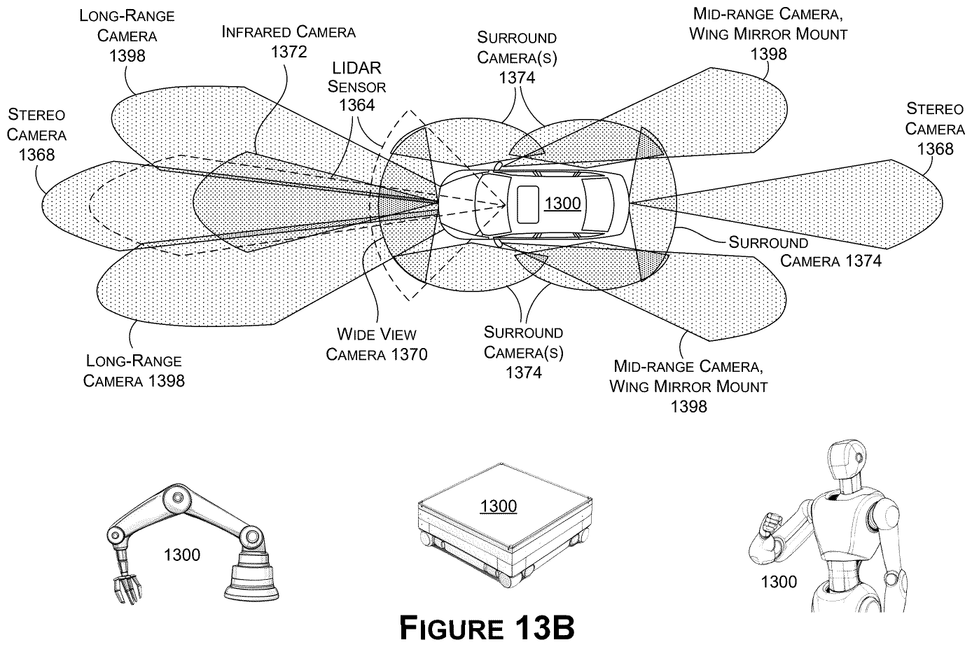

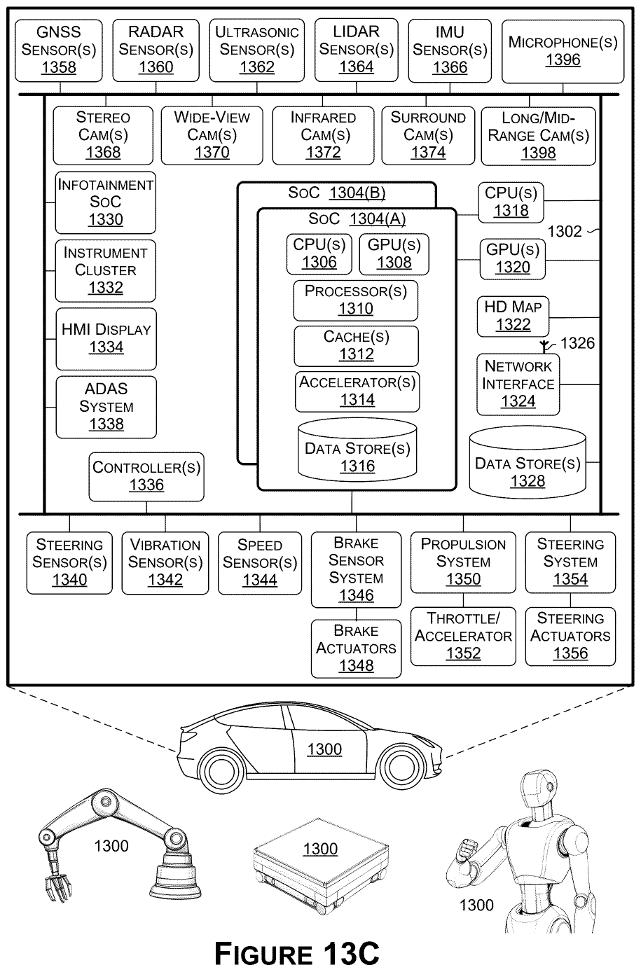

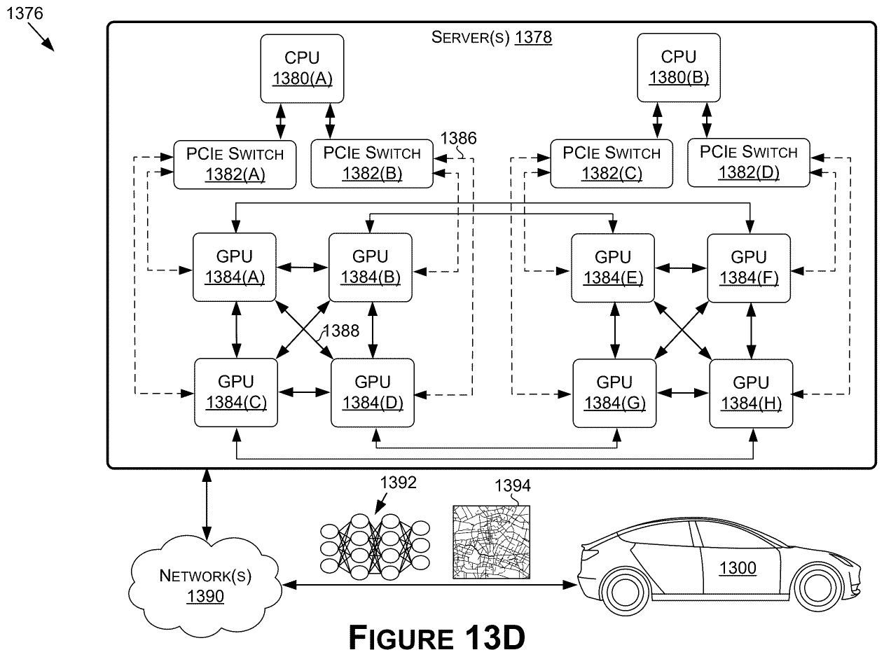

FIG. 13A is an illustration of an example autonomous or semi-autonomous vehicle or machine 1300, in accordance with some embodiments of the present disclosure. The autonomous or semi-autonomous vehicle or machine 1300 (alternatively referred to herein as the “vehicle 1300,” “machine 1300,” “ego-vehicle 1300,” “ego-machine 1300,” “robot 1300,” etc.) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers) or robot (e.g., autonomous mobile robots (AMRs), industrial robots, delivery drones, humanoid robots, surgical robots, robotic arms, etc.). Taking autonomous vehicles as an example, autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J 3016-201609, published on Sep. 30, 2016, and previous and future versions of this standard). The vehicle 1300 may be capable of functionality in accordance with one or more of Level 3-Level 5 of the autonomous driving levels. The vehicle 1300 may be capable of functionality in accordance with one or more of Level 1-Level 5 of the autonomous driving levels. For example, the vehicle 1300 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1300 or other machine, such as being fully autonomous, being highly autonomous, being conditionally autonomous, being partially autonomous, providing assistive autonomy, being semi-autonomous, being primarily autonomous, or other designation. Although some embodiments are described in which the machine 1300 is an autonomous or semi-autonomous vehicle, those of ordinary skill in the art will understand how to adapt the applicable techniques described herein to other types of machines or robots.

The vehicle 1300 may include components such as a chassis, a vehicle body, wheels (e.g., 2, 4, 6, 8, 18, etc.), tires, axles, and other components of a vehicle. The vehicle 1300 may include a propulsion system 1350, such as an internal combustion engine, hybrid electric power plant, an all-electric engine, and/or another propulsion system type. The propulsion system 1350 may be connected to a drive train of the vehicle 1300, which may include a transmission, to allow the propulsion of the vehicle 1300. The propulsion system 1350 may be controlled in response to receiving signals from the throttle/accelerator 1352.

A steering system 1354, which may include a steering wheel, may be used to steer the vehicle 1300 (e.g., along a desired path or route) when the propulsion system 1350 is operating (e.g., when the vehicle is in motion). The steering system 1354 may receive signals from a steering actuator 1356. The steering wheel may be optional for full automation (Level 5) functionality.

The brake sensor system 1346 may be used to operate the vehicle brakes in response to receiving signals from the brake actuators 1348 and/or brake sensors.

Controller(s) 1336, which may include one or more system on chips (SoCs) 1304 (FIG. 13C) and/or GPU(s), may provide signals (e.g., representative of commands) to one or more components and/or systems of the vehicle 1300. For example, the controller(s) may send signals to operate the vehicle brakes via one or more brake actuators 1348, to operate the steering system 1354 via one or more steering actuators 1356, to operate the propulsion system 1350 via one or more throttle/accelerators 1352. The controller(s) 1336 may include one or more onboard (e.g., integrated) computing devices (e.g., supercomputers) that process sensor signals, and output operation commands (e.g., signals representing commands) to allow autonomous driving and/or to assist a human driver in driving the vehicle 1300. The controller(s) 1336 may include a first controller 1336 for autonomous driving functions, a second controller 1336 for functional safety functions, a third controller 1336 for artificial intelligence functionality (e.g., computer vision), a fourth controller 1336 for infotainment functionality, a fifth controller 1336 for redundancy in emergency conditions, and/or other controllers. In some examples, a single controller 1336 may handle two or more of the above functionalities, two or more controllers 1336 may handle a single functionality, and/or any combination thereof.

The controller(s) 1336 may provide the signals for controlling one or more components and/or systems of the vehicle 1300 in response to sensor data received from one or more sensors (e.g., sensor inputs). The sensor data may be received from, for example and without limitation, global navigation satellite systems (“GNSS”) sensor(s) 1358 (e.g., Global Positioning System sensor(s)), RADAR sensor(s) 1360, ultrasonic sensor(s) 1362, LiDAR sensor(s) 1364, inertial measurement unit (IMU) sensor(s) 1366 (e.g., accelerometer(s), gyroscope(s), magnetic compass(es), magnetometer(s), etc.), microphone(s) 1396, stereo camera(s) 1368, wide-view camera(s) 1370 (e.g., fisheye cameras), infrared camera(s) 1372, surround camera(s) 1374 (e.g., 360 degree cameras), long-range and/or mid-range camera(s) 1398, speed sensor(s) 1344 (e.g., for measuring the speed of the vehicle 1300), vibration sensor(s) 1342, steering sensor(s) 1340, brake sensor(s) (e.g., as part of the brake sensor system 1346), one or more occupant monitoring system (OMS) sensor(s) 1301 (e.g., one or more interior cameras), and/or other sensor types.

One or more of the controller(s) 1336 may receive inputs (e.g., represented by input data) from an instrument cluster 1332 of the vehicle 1300 and provide outputs (e.g., represented by output data, display data, etc.) via a human-machine interface (HMI) display 1334, an audible annunciator, a loudspeaker, and/or via other components of the vehicle 1300. The outputs may include information such as vehicle velocity, speed, time, map data (e.g., the High Definition (“HD”) map 1322 of FIG. 13C), location data (e.g., the vehicle's 1300 location, such as on a map), direction, location of other vehicles (e.g., an occupancy grid), information about objects and status of objects as perceived by the controller(s) 1336, etc. For example, the HMI display 1334 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1300 further includes a network interface 1324 which may use one or more wireless antenna(s) 1326 and/or modem(s) to communicate over one or more networks. For example, the network interface 1324 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1326 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 13B is an example of camera locations and fields of view for the example autonomous vehicle 1300 of FIG. 13A, in accordance with some embodiments of the present disclosure. The cameras and respective fields of view are one example embodiment and are not intended to be limiting. For example, additional and/or alternative cameras may be included and/or the cameras may be located at different locations on the vehicle 1300.

The camera types for the cameras may include, but are not limited to, digital cameras that may be adapted for use with the components and/or systems of the vehicle 1300. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1300 (e.g., front-facing cameras) may be used for surround view, to help identify forward facing paths and obstacles, as well aid in, with the help of one or more controllers 1336 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1370 that may be used to perceive objects coming into view from the periphery (e.g., pedestrians, crossing traffic or bicycles). Although only one wide-view camera is illustrated in FIG. 13B, there may be any number (including zero) of wide-view cameras 1370 on the vehicle 1300. In addition, any number of long-range camera(s) 1398 (e.g., a long-view stereo camera pair) may be used for depth-based object detection, especially for objects for which a neural network has not yet been trained. The long-range camera(s) 1398 may also be used for object detection and classification, as well as basic object tracking.

Any number of stereo cameras 1368 may also be included in a front-facing configuration. In at least one embodiment, one or more of stereo camera(s) 1368 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1368 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1368 may be used in addition to, or alternatively from, those described herein.

Cameras with a field of view that include portions of the environment to the side of the vehicle 1300 (e.g., side-view cameras) may be used for surround view, providing information used to create and update the occupancy grid, as well as to generate side impact collision warnings. For example, surround camera(s) 1374 (e.g., four surround cameras 1374 as illustrated in FIG. 13B) may be positioned to on the vehicle 1300. The surround camera(s) 1374 may include wide-view camera(s) 1370, fisheye camera(s), 360 degree camera(s), and/or the like. Four example, four fisheye cameras may be positioned on the vehicle's front, rear, and sides. In an alternative arrangement, the vehicle may use three surround camera(s) 1374 (e.g., left, right, and rear), and may leverage one or more other camera(s) (e.g., a forward-facing camera) as a fourth surround view camera.

Cameras with a field of view that include portions of the environment to the rear of the vehicle 1300 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1398, stereo camera(s) 1368), infrared camera(s) 1372, etc.), as described herein.

Cameras with a field of view that include portions of the interior environment within the cabin of the vehicle 1300 (e.g., one or more OMS sensor(s) 1301) may be used as part of an occupant monitoring system (OMS) such as, but not limited to, a driver monitoring system (DMS). For example, OMS sensors (e.g., the OMS sensor(s) 1301) may be used (e.g., by the controller(s) 1336) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 13C is a block diagram of an example system architecture for the example autonomous vehicle 1300 of FIG. 13A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1300 in FIG. 13C are illustrated as being connected via bus 1302. The bus 1302 may include a Controller Area Network (CAN) data interface (alternatively referred to herein as a “CAN bus”). A CAN may be a network inside the vehicle 1300 used to aid in control of various features and functionality of the vehicle 1300, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1302 is described herein as being a CAN bus, this is not intended to be limiting. For example, in addition to, or alternatively from, the CAN bus, FlexRay and/or Ethernet may be used. Additionally, although a single line is used to represent the bus 1302, this is not intended to be limiting. For example, there may be any number of busses 1302, which may include one or more CAN busses, one or more FlexRay busses, one or more Ethernet busses, and/or one or more other types of busses using a different protocol. In some examples, two or more busses 1302 may be used to perform different functions, and/or may be used for redundancy. For example, a first bus 1302 may be used for collision avoidance functionality and a second bus 1302 may be used for actuation control. In any example, each bus 1302 may communicate with any of the components of the vehicle 1300, and two or more busses 1302 may communicate with the same components. In some examples, each SoC 1304, each controller 1336, and/or each computer within the vehicle may have access to the same input data (e.g., inputs from sensors of the vehicle 1300), and may be connected to a common bus, such the CAN bus.

The vehicle 1300 may include one or more controller(s) 1336, such as those described herein with respect to FIG. 13A. The controller(s) 1336 may be used for a variety of functions. The controller(s) 1336 may be coupled to any of the various other components and systems of the vehicle 1300, and may be used for control of the vehicle 1300, artificial intelligence of the vehicle 1300, infotainment for the vehicle 1300, and/or the like.

The vehicle 1300 may include a system(s) on a chip (SoC) 1304. The SoC 1304 may include CPU(s) 1306, GPU(s) 1308, processor(s) 1310, cache(s) 1312, accelerator(s) 1314, data store(s) 1316, and/or other components and features not illustrated. The SoC(s) 1304 may be used to control the vehicle 1300 in a variety of platforms and systems. For example, the SoC(s) 1304 may be combined in a system (e.g., the system of the vehicle 1300) with an HD map 1322 which may obtain map refreshes and/or updates via a network interface 1324 from one or more servers (e.g., server(s) 1378 of FIG. 13D).

The CPU(s) 1306 may include a CPU cluster or CPU complex (alternatively referred to herein as a “CCPLEX”). The CPU(s) 1306 may include multiple cores and/or L2 caches. For example, in some embodiments, the CPU(s) 1306 may include eight cores in a coherent multi-processor configuration. In some embodiments, the CPU(s) 1306 may include four dual-core clusters where each cluster has a dedicated L2 cache (e.g., a 2 MB L2 cache). The CPU(s) 1306 (e.g., the CCPLEX) may be configured to support simultaneous cluster operation allowing any combination of the clusters of the CPU(s) 1306 to be active at any given time.

The CPU(s) 1306 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1306 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1308 may include an integrated GPU (alternatively referred to herein as an “iGPU”). The GPU(s) 1308 may be programmable and may be efficient for parallel workloads. The GPU(s) 1308, in some examples, may use an enhanced tensor instruction set. The GPU(s) 1308 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1308 may include at least eight streaming microprocessors. The GPU(s) 1308 may use compute application programming interface(s) (API(s)). In addition, the GPU(s) 1308 may use one or more parallel computing platforms and/or programming models (e.g., NVIDIA's CUDA).

The GPU(s) 1308 may be power-optimized for best performance in automotive and embedded use cases. For example, the GPU(s) 1308 may be fabricated on a Fin field-effect transistor (FinFET). However, this is not intended to be limiting and the GPU(s) 1308 may be fabricated using other semiconductor manufacturing processes. Each streaming microprocessor may incorporate a number of mixed-precision processing cores partitioned into multiple blocks. For example, and without limitation, 64 PF32 cores and 32 PF 64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 1308 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1308 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1308 to access the CPU(s) 1306 page tables directly. In such examples, when the GPU(s) 1308 memory management unit (MMU) experiences a miss, an address translation request may be transmitted to the CPU(s) 1306. In response, the CPU(s) 1306 may look in its page tables for the virtual-to-physical mapping for the address and transmits the translation back to the GPU(s) 1308. As such, unified memory technology may allow a single unified virtual address space for memory of both the CPU(s) 1306 and the GPU(s) 1308, thereby simplifying the GPU(s) 1308 programming and porting of applications to the GPU(s) 1308.

In addition, the GPU(s) 1308 may include an access counter that may keep track of the frequency of access of the GPU(s) 1308 to memory of other processors. The access counter may help ensure that memory pages are moved to the physical memory of the processor that is accessing the pages most frequently.

The SoC(s) 1304 may include any number of cache(s) 1312, including those described herein. For example, the cache(s) 1312 may include an L3 cache that is available to both the CPU(s) 1306 and the GPU(s) 1308 (e.g., that is connected both the CPU(s) 1306 and the GPU(s) 1308). The cache(s) 1312 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1304 may include an arithmetic logic unit(s) (ALU(s)) which may be leveraged in performing processing with respect to any of the variety of tasks or operations of the vehicle 1300—such as processing DNNs. In addition, the SoC(s) 1304 may include a floating point unit(s) (FPU(s))—or other math coprocessor or numeric coprocessor types—for performing mathematical operations within the system. For example, the SoC(s) 1304 may include one or more FPUs integrated as execution units within a CPU(s) 1306 and/or GPU(s) 1308.

The SoC(s) 1304 may include one or more accelerators 1314 (e.g., hardware accelerators, software accelerators, or a combination thereof). For example, the SoC(s) 1304 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 1308 and to off-load some of the tasks of the GPU(s) 1308 (e.g., to free up more cycles of the GPU(s) 1308 for performing other tasks). As an example, the accelerator(s) 1314 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1314 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1308, and by using an inference accelerator, for example, a designer may target either the DLA(s) or the GPU(s) 1308 for any function. For example, the designer may focus processing of CNNs and floating point operations on the DLA(s) and leave other functions to the GPU(s) 1308 and/or other accelerator(s) 1314.

The accelerator(s) 1314 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 1306. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1314 (e.g., the hardware acceleration cluster) may include a computer vision network on-chip and SRAM, for providing a high-bandwidth, low latency SRAM for the accelerator(s) 1314. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1304 may include a real-time ray-tracing hardware accelerator, such as described in U.S. Pat. No. 10,885,698, issued on Jan. 5, 2021. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 1314 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1366 output that correlates with the vehicle 1300 orientation, distance, 3D location estimates of the object obtained from the neural network and/or other sensors (e.g., LiDAR sensor(s) 1364 or RADAR sensor(s) 1360), among others.

The SoC(s) 1304 may include data store(s) 1316 (e.g., memory). The data store(s) 1316 may be on-chip memory of the SoC(s) 1304, which may store neural networks to be executed on the GPU and/or the DLA. In some examples, the data store(s) 1316 may be large enough in capacity to store multiple instances of neural networks for redundancy and safety. The data store(s) 1316 may comprise L2 or L3 cache(s) 1312. Reference to the data store(s) 1316 may include reference to the memory associated with the PVA, DLA, and/or other accelerator(s) 1314, as described herein.

The SoC(s) 1304 may include one or more processor(s) 1310 (e.g., embedded processors). The processor(s) 1310 may include a boot and power management processor that may be a dedicated processor and subsystem to handle boot power and management functions and related security enforcement. The boot and power management processor may be a part of the SoC(s) 1304 boot sequence and may provide runtime power management services. The boot power and management processor may provide clock and voltage programming, assistance in system low power state transitions, management of SoC(s) 1304 thermals and temperature sensors, and/or management of the SoC(s) 1304 power states. Each temperature sensor may be implemented as a ring-oscillator whose output frequency is proportional to temperature, and the SoC(s) 1304 may use the ring-oscillators to detect temperatures of the CPU(s) 1306, GPU(s) 1308, and/or accelerator(s) 1314. If temperatures are determined to exceed a threshold, the boot and power management processor may enter a temperature fault routine and put the SoC(s) 1304 into a lower power state and/or put the vehicle 1300 into a chauffeur to safe stop mode (e.g., bring the vehicle 1300 to a safe stop).

The processor(s) 1310 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1310 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1310 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1310 may further include a real-time camera engine that may include a dedicated processor subsystem for handling real-time camera management.

The processor(s) 1310 may further include a high-dynamic range signal processor that may include an image signal processor that is a hardware engine that is part of the camera processing pipeline.

The processor(s) 1310 may include a video image compositor that may be a processing block (e.g., implemented on a microprocessor) that implements video post-processing functions needed by a video playback application to produce the final image for the player window. The video image compositor may perform lens distortion correction on wide-view camera(s) 1370, surround camera(s) 1374, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1308 is not required to continuously render new surfaces. Even when the GPU(s) 1308 is powered on and active doing 3D rendering, the video image compositor may be used to offload the GPU(s) 1308 to improve performance and responsiveness.

The SoC(s) 1304 may further include a mobile industry processor interface (MIPI) camera serial interface for receiving video and input from cameras, a high-speed interface, and/or a video input block that may be used for camera and related pixel input functions. The SoC(s) 1304 may further include an input/output controller(s) that may be controlled by software and may be used for receiving I/O signals that are uncommitted to a specific role.

The SoC(s) 1304 may further include a broad range of peripheral interfaces to allow communication with peripherals, audio codecs, power management, and/or other devices. The SoC(s) 1304 may be used to process data from cameras (e.g., connected over Gigabit Multimedia Serial Link and Ethernet), sensors (e.g., LiDAR sensor(s) 1364, RADAR sensor(s) 1360, etc. that may be connected over Ethernet), data from bus 1302 (e.g., speed of vehicle 1300, steering wheel position, etc.), data from GNSS sensor(s) 1358 (e.g., connected over Ethernet or CAN bus). The SoC(s) 1304 may further include dedicated high-performance mass storage controllers that may include their own DMA engines, and that may be used to free the CPU(s) 1306 from routine data management tasks.

The SoC(s) 1304 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1304 may be faster, more reliable, and even more energy-efficient and space-efficient than conventional systems. For example, the accelerator(s) 1314, when combined with the CPU(s) 1306, the GPU(s) 1308, and the data store(s) 1316, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 1320) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1308.

In some examples, a CNN for facial recognition and vehicle owner identification may use data from camera sensors to identify the presence of an authorized driver and/or owner of the vehicle 1300. The always on sensor processing engine may be used to unlock the vehicle when the owner approaches the driver door and turn on the lights, and, in security mode, to disable the vehicle when the owner leaves the vehicle. In this way, the SoC(s) 1304 provide for security against theft and/or carjacking.

In another example, a CNN for emergency vehicle detection and identification may use data from microphones 1396 to detect and identify emergency vehicle sirens. In contrast to conventional systems, that use general classifiers to detect sirens and manually extract features, the SoC(s) 1304 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1358. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1362, until the emergency vehicle(s) passes.

The vehicle may include a CPU(s) 1318 (e.g., discrete CPU(s), or dCPU(s)), that may be coupled to the SoC(s) 1304 via a high-speed interconnect (e.g., PCIe). The CPU(s) 1318 may include an X86 processor, for example. The CPU(s) 1318 may be used to perform any of a variety of functions, including arbitrating potentially inconsistent results between ADAS sensors and the SoC(s) 1304, and/or monitoring the status and health of the controller(s) 1336 and/or infotainment SoC 1330, for example.

The vehicle 1300 may include a GPU(s) 1320 (e.g., discrete GPU(s), or dGPU(s)), that may be coupled to the SoC(s) 1304 via a high-speed interconnect (e.g., NVIDIA's NVLINK). The GPU(s) 1320 may provide additional artificial intelligence functionality, such as by executing redundant and/or different neural networks, and may be used to train and/or update neural networks based on input (e.g., sensor data) from sensors of the vehicle 1300.

The vehicle 1300 may further include the network interface 1324 which may include one or more wireless antennas 1326 (e.g., one or more wireless antennas for different communication protocols, such as a cellular antenna, a Bluetooth antenna, etc.). The network interface 1324 may be used to allow wireless connectivity over the Internet with the cloud (e.g., with the server(s) 1378 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1300 information about vehicles in proximity to the vehicle 1300 (e.g., vehicles in front of, on the side of, and/or behind the vehicle 1300). This functionality may be part of a cooperative adaptive cruise control functionality of the vehicle 1300.

The network interface 1324 may include a SoC that provides modulation and demodulation functionality and enables the controller(s) 1336 to communicate over wireless networks. The network interface 1324 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1300 may further include data store(s) 1328 which may include off-chip (e.g., off the SoC(s) 1304) storage. The data store(s) 1328 may include one or more storage elements including RAM, SRAM, DRAM, VRAM, Flash, hard disks, and/or other components and/or devices that may store at least one bit of data.

The vehicle 1300 may further include GNSS sensor(s) 1358. The GNSS sensor(s) 1358 (e.g., GPS, assisted GPS sensors, differential GPS (DGPS) sensors, etc.), to assist in mapping, perception, occupancy grid generation, and/or path planning functions. Any number of GNSS sensor(s) 1358 may be used, including, for example and without limitation, a GPS using a USB connector with an Ethernet to Serial (RS-232) bridge.

The vehicle 1300 may further include RADAR sensor(s) 1360. The RADAR sensor(s) 1360 may be used by the vehicle 1300 for long-range vehicle detection, even in darkness and/or severe weather conditions. RADAR functional safety levels may be ASIL B. The RADAR sensor(s) 1360 may use the CAN and/or the bus 1302 (e.g., to transmit data generated using the RADAR sensor(s) 1360) for control and to access object tracking data, with access to Ethernet to access raw data in some examples. A wide variety of RADAR sensor types may be used. For example, and without limitation, the RADAR sensor(s) 1360 may be suitable for front, rear, and side RADAR use. In some example, Pulse Doppler RADAR sensor(s) are used.

The RADAR sensor(s) 1360 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1360 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1300 surroundings at higher speeds with minimal interference from traffic in adjacent lanes. The other two antennae may expand the field of view, making it possible to quickly detect vehicles entering or leaving the vehicle's 1300 lane.

Mid-range RADAR systems may include, as an example, a range of up to 1360m (front) or 80 m (rear), and a field of view of up to 42 degrees (front) or 1350 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1300 may further include ultrasonic sensor(s) 1362. The ultrasonic sensor(s) 1362, which may be positioned at the front, back, and/or the sides of the vehicle 1300, may be used for park assist and/or to create and update an occupancy grid. A wide variety of ultrasonic sensor(s) 1362 may be used, and different ultrasonic sensor(s) 1362 may be used for different ranges of detection (e.g., 2.5 m, 4 m). The ultrasonic sensor(s) 1362 may operate at functional safety levels of ASIL B.

The vehicle 1300 may include LiDAR sensor(s) 1364. The LiDAR sensor(s) 1364 may be used for object and pedestrian detection, emergency braking, collision avoidance, and/or other functions. The LiDAR sensor(s) 1364 may be functional safety level ASIL B. In some examples, the vehicle 1300 may include multiple LiDAR sensors 1364 (e.g., two, four, six, etc.) that may use Ethernet (e.g., to provide data to a Gigabit Ethernet switch).

In some examples, the LiDAR sensor(s) 1364 may be capable of providing a list of objects and their distances for a 360-degree field of view. Commercially available LiDAR sensor(s) 1364 may have an advertised range of approximately 1300m, with an accuracy of 2cm-3cm, and with support for a 1300 Mbps Ethernet connection, for example. In some examples, one or more non-protruding LiDAR sensors 1364 may be used. In such examples, the LiDAR sensor(s) 1364 may be implemented as a small device that may be embedded into the front, rear, sides, and/or corners of the vehicle 1300. The LiDAR sensor(s) 1364, in such examples, may provide up to a 120-degree horizontal and 35-degree vertical field-of-view, with a 200 m range even for low-reflectivity objects. Front-mounted LiDAR sensor(s) 1364 may be configured for a horizontal field of view between 45 degrees and 135 degrees. FIG. 13B illustrates example long-range and short-range horizontal fields-of-view for a LiDAR sensor 1364 with an example mounting location above the windshield, but other configurations such as those that include a grille-mounted LiDAR sensor 1364 (e.g., as illustrated in FIG. 13A) and/or a roof-mounted LiDAR scanner (e.g., for a data collection vehicle) are possible.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 1300. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1364 may be less susceptible to motion blur, vibration, and/or shock.

The vehicle may further include IMU sensor(s) 1366. The IMU sensor(s) 1366 may be located at a center of the rear axle of the vehicle 1300, in some examples. The IMU sensor(s) 1366 may include, for example and without limitation, an accelerometer(s), a magnetometer(s), a gyroscope(s), a magnetic compass(es), and/or other sensor types. In some examples, such as in six-axis applications, the IMU sensor(s) 1366 may include accelerometers and gyroscopes, while in nine-axis applications, the IMU sensor(s) 1366 may include accelerometers, gyroscopes, and magnetometers.

In some embodiments, the IMU sensor(s) 1366 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1366 may allow the vehicle 1300 to estimate heading without requiring input from a magnetic sensor by directly observing and correlating the changes in velocity from GPS to the IMU sensor(s) 1366. In some examples, the IMU sensor(s) 1366 and the GNSS sensor(s) 1358 may be combined in a single integrated unit.

The vehicle may include microphone(s) 1396 placed in and/or around the vehicle 1300. The microphone(s) 1396 may be used for emergency vehicle detection and identification, among other things.

The vehicle may further include any number of camera types, including stereo camera(s) 1368, wide-view camera(s) 1370, infrared camera(s) 1372, surround camera(s) 1374, long-range and/or mid-range camera(s) 1398, and/or other camera types. The cameras may be used to capture image data around an entire periphery of the vehicle 1300. The types of cameras used depends on the embodiments and requirements for the vehicle 1300, and any combination of camera types may be used to provide the necessary coverage around the vehicle 1300. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 13A and FIG. 13B.

The vehicle 1300 may further include vibration sensor(s) 1342. The vibration sensor(s) 1342 may measure vibrations of components of the vehicle, such as the axle(s). For example, changes in vibrations may indicate a change in road surfaces. In another example, when two or more vibration sensors 1342 are used, the differences between the vibrations may be used to determine friction or slippage of the road surface (e.g., when the difference in vibration is between a power-driven axle and a freely rotating axle).

The vehicle 1300 may include an ADAS system 1338. The ADAS system 1338 may include a SoC, in some examples. The ADAS system 1338 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1360, LiDAR sensor(s) 1364, and/or a camera(s). The ACC systems may include longitudinal ACC and/or lateral ACC. Longitudinal ACC monitors and controls the distance to the vehicle immediately ahead of the vehicle 1300 and automatically adjust the vehicle speed to maintain a safe distance from vehicles ahead. Lateral ACC performs distance keeping, and advises the vehicle 1300 to change lanes when necessary. Lateral ACC is related to other ADAS applications such as LCA and CWS.

CACC uses information from other vehicles that may be received via the network interface 1324 and/or the wireless antenna(s) 1326 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1300), while the I2V communication concept provides information about traffic further ahead. CACC systems may include either or both I2V and V2V information sources. Given the information of the vehicles ahead of the vehicle 1300, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1360, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1360, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1300 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1300 if the vehicle 1300 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1360, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1300 is backing up. Some RCTW systems include AEB to ensure that the vehicle brakes are applied to avoid a crash. RCTW systems may use one or more rear-facing RADAR sensor(s) 1360, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1300, the vehicle 1300 itself must, in the case of conflicting results, decide whether to heed the result from a primary computer or a secondary computer (e.g., a first controller 1336 or a second controller 1336). For example, in some embodiments, the ADAS system 1338 may be a backup and/or secondary computer for providing perception information to a backup computer rationality module. The backup computer rationality monitor may run a redundant diverse software on hardware components to detect faults in perception and dynamic driving tasks. Outputs from the ADAS system 1338 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1304.

In other examples, ADAS system 1338 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1338 may be fed into the primary computer's perception block and/or the primary computer's dynamic driving task block. For example, if the ADAS system 1338 indicates a forward crash warning due to an object immediately ahead, the perception block may use this information when identifying objects. In other examples, the secondary computer may have its own neural network which is trained and thus reduces the risk of false positives, as described herein.

The vehicle 1300 may further include the infotainment SoC 1330 (e.g., an in-vehicle infotainment system (IVI)). Although illustrated and described as a SoC, the infotainment system may not be a SoC, and may include two or more discrete components. The infotainment SoC 1330 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1300. For example, the infotainment SoC 1330 may radios, disk players, navigation systems, video players, USB and Bluetooth connectivity, carputers, in-car entertainment, Wi-Fi, steering wheel audio controls, hands free voice control, a heads-up display (HUD), an HMI display 1334, a telematics device, a control panel (e.g., for controlling and/or interacting with various components, features, and/or systems), and/or other components. The infotainment SoC 1330 may further be used to provide information (e.g., visual and/or audible) to a user(s) of the vehicle, such as information from the ADAS system 1338, autonomous driving information such as planned vehicle maneuvers, trajectories, surrounding environment information (e.g., intersection information, vehicle information, road information, etc.), and/or other information.

The infotainment SoC 1330 may include GPU functionality. The infotainment SoC 1330 may communicate over the bus 1302 (e.g., CAN bus, Ethernet, etc.) with other devices, systems, and/or components of the vehicle 1300. In some examples, the infotainment SoC 1330 may be coupled to a supervisory MCU such that the GPU of the infotainment system may perform some self-driving functions in the event that the primary controller(s) 1336 (e.g., the primary and/or backup computers of the vehicle 1300) fail. In such an example, the infotainment SoC 1330 may put the vehicle 1300 into a chauffeur to safe stop mode, as described herein.

The vehicle 1300 may further include an instrument cluster 1332 (e.g., a digital dash, an electronic instrument cluster, a digital instrument panel, etc.). The instrument cluster 1332 may include a controller and/or supercomputer (e.g., a discrete controller or supercomputer). The instrument cluster 1332 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1330 and the instrument cluster 1332. As such, the instrument cluster 1332 may be included as part of the infotainment SoC 1330, or vice versa.

FIG. 13D is a system diagram for communication between cloud-based server(s) and the example autonomous vehicle 1300 of FIG. 13A, in accordance with some embodiments of the present disclosure. The system 1376 may include server(s) 1378, network(s) 1390, and vehicles, including the vehicle 1300. The server(s) 1378 may include a plurality of GPUs 1384(A)-1384(H) (collectively referred to herein as GPUs 1384), PCIe switches 1382(A)-1382(D) (collectively referred to herein as PCIe switches 1382), and/or CPUs 1380(A)-1380(B) (collectively referred to herein as CPUs 1380). The GPUs 1384, the CPUs 1380, and the PCIe switches may be interconnected with high-speed interconnects such as, for example and without limitation, NVLink interfaces 1388 developed by NVIDIA and/or PCIe connections 1386. In some examples, the GPUs 1384 are connected via NVLink and/or NVSwitch SoC and the GPUs 1384 and the PCIe switches 1382 are connected via PCIe interconnects. Although eight GPUs 1384, two CPUs 1380, and two PCIe switches are illustrated, this is not intended to be limiting. Depending on the embodiment, each of the server(s) 1378 may include any number of GPUs 1384, CPUs 1380, and/or PCIe switches. For example, the server(s) 1378 may each include eight, sixteen, thirty-two, and/or more GPUs 1384.

The server(s) 1378 may receive, over the network(s) 1390 and from the vehicles, image data representative of images showing unexpected or changed road conditions, such as recently commenced road-work. The server(s) 1378 may transmit, over the network(s) 1390 and to the vehicles, neural networks 1392, updated neural networks 1392, and/or map information 1394, including information regarding traffic and road conditions. The updates to the map information 1394 may include updates for the HD map 1322, such as information regarding construction sites, potholes, detours, flooding, and/or other obstructions. In some examples, the neural networks 1392, the updated neural networks 1392, and/or the map information 1394 may have resulted from new training and/or experiences represented in data received from any number of vehicles in the environment, and/or based on training performed at a datacenter (e.g., using the server(s) 1378 and/or other servers).

The server(s) 1378 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1390, and/or the machine learning models may be used by the server(s) 1378 to remotely monitor the vehicles.

In some examples, the server(s) 1378 may receive data from the vehicles and apply the data to up-to-date real-time neural networks for real-time intelligent inferencing. The server(s) 1378 may include deep-learning supercomputers and/or dedicated AI computers powered by GPU(s) 1384, such as a DGX and DGX Station machines developed by NVIDIA. However, in some examples, the server(s) 1378 may include deep learning infrastructure that use only CPU-powered datacenters.

The deep-learning infrastructure of the server(s) 1378 may be capable of fast, real-time inferencing, and may use that capability to evaluate and verify the health of the processors, software, and/or associated hardware in the vehicle 1300. For example, the deep-learning infrastructure may receive periodic updates from the vehicle 1300, such as a sequence of images and/or objects that the vehicle 1300 has located in that sequence of images (e.g., via computer vision and/or other machine learning object classification techniques). The deep-learning infrastructure may run its own neural network to identify the objects and compare them with the objects identified by the vehicle 1300 and, if the results do not match and the infrastructure concludes that the AI in the vehicle 1300 is malfunctioning, the server(s) 1378 may transmit a signal to the vehicle 1300 instructing a fail-safe computer of the vehicle 1300 to assume control, notify the passengers, and complete a safe parking maneuver.

For inferencing, the server(s) 1378 may include the GPU(s) 1384 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE LITERAL SUPPORT

The disclosure of this application also includes the following numbered clauses:

Clause 1. One or more processors comprising processing circuitry to generate an updated version of a robotics foundation model based at least on training instances of the robotics foundation model in parallel in one or more training clusters in at least one of a hub data center or one or more spoke data centers using supervised learning and training data comprising a set of synthetic videos retrieved from a networked file system in the hub data center.

Clause 2. The one or more processors of clause 1, wherein the processing circuitry is further to store, in the networked file system in the hub data center, one or more additional synthetic videos generated based at least on performing synthetic data generation using instances of a simulation environment running in parallel in one or more simulation clusters in at least one of the hub data center or the one or more spoke data centers.

Clause 3. The one or more processors of clause 1 or 2, wherein the processing circuitry is further to run the supervised learning and the synthetic data generation in one or more iterations of a cyclic workflow.

Clause 4. The one or more processors of clause 1, 2 or 3, wherein the hub data center and the one or more spoke data centers are connected in a hub-and-spoke model.

Clause 5. The one or more processors of clause 1, 2 or 3, wherein the one or more training clusters in the hub data center and the one or more simulation clusters in the one or more spoke data centers connect to the networked file system in the hub data center.

Clause 6. The one or more processors of clause 1, 2 or 3, wherein the one or more simulation clusters in the one or more spoke data centers connect to the networked file system in the hub data center via at least one a direct interconnect or a dedicated private link.

Clause 7. The one or more processors of clause 1, 2 or 3, wherein the processing circuitry is further to transmit the one or more additional synthetic videos from the one or more spoke data centers to the networked file system in the hub data center via at least one of a direct interconnect or a dedicated private link.

Clause 8. The one or more processors of clause 1, 2 or 3, wherein the hub data center and the one or more spoke data centers are hosted by different cloud service providers.

Clause 9. The one or more processors of clause 8, wherein the processing circuitry is further to transmit the one or more additional synthetic videos from the one or more spoke data centers to the networked file system in the hub data center via at least one of a direct interconnect or a dedicated private link provided by at least one of the different cloud service providers.

Clause 10. The one or more processors of clause 1, 2 or 3, wherein the processing circuitry is further to asynchronously back up one or more of the synthetic videos from the networked file system in the hub data center to object storage in the hub data center, and copy the one or more of the synthetic videos from the object storage to the networked file system based at least on one or more supervised learning jobs associated with the one or more of the synthetic videos.

Clause 11. The one or more processors of clause 1, 2 or 3, wherein the one or more training clusters in at least one of the hub data center or the one or more spoke data centers comprise a type of compute node equipped with one or more AI or deep learning accelerators.

Clause 12. The one or more processors of clause 1, 2 or 3, wherein the one or more simulation clusters in the one or more spoke data centers comprise a type of compute node equipped with one or more ray-tracing accelerators.

Clause 13. The one or more processors of clause 1, 2 or 3, wherein the processing circuitry is further to run the supervised learning in the hub data center and the synthetic data generation in the one or more spoke data centers in parallel in the one or more iterations of the cyclic workflow.

Clause 14. The one or more processors of clause 1, 2 or 3, wherein the processing circuitry is further to run the supervised learning using a set of real videos that form a portion of the training data that increases with successive iterations of the one or more iterations of the cyclic workflow.

Clause 15. The one or more processors of clause 1, 2 or 3, wherein at least one of the one or more processors are comprised in at least one of: a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially using cloud computing resources; a system using or deploying one or more inference microservices; or a system that incorporates one or more machine learning models deployed in a service or microservice along with an OS-level virtualization package (e.g., a container).

Clause 16. A method comprising operating one or more iterations of a loop comprising i) supervised learning jobs that generate one or more updated versions of a robotics foundation model based at least on training, in parallel in one or more training clusters in at least one of a hub data center or one or more spoke data centers, instances of the robotics foundation model using training data comprising a set of synthetic videos retrieved from a networked file system in the hub data center, and ii) synthetic data generation jobs that store, in the networked file system in the hub data center, additional synthetic videos generated using instances of a simulation environment running in parallel in one or more simulation clusters in at least one of the hub data center or the one or more spoke data centers.

Clause 17. The method of clause 16, wherein the one or more training clusters in the hub data center and the one or more simulation clusters in the one or more spoke data centers connect to the networked file system in the hub data center.

Clause 18. The method of clause 16, wherein the method is performed by at least one of: a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially using cloud computing resources; a system using or deploying one or more inference microservices; or a system that incorporates one or more machine learning models deployed in a service or microservice along with an OS-level virtualization package (e.g., a container).

Clause 19. A system comprising one or more processors to store, in a networked file system in a hub data center, an updated version of a robotics foundation model generated based at least on training instances of the robotics foundation model in parallel in one or more training clusters in at least one of a hub data center or one or more spoke data centers using supervised learning and training data comprising a set of synthetic videos retrieved from the networked file system in the hub data center.

Clause 20. The system of clause 19, wherein at least some synthetic videos of the set of synthetic videos are generated in parallel in one or more simulation clusters in at least one of the hub data center or the one or more spoke data centers using one or more simulations rendered using one or more light transport simulation algorithms.

Clause 21. The system of clause 19 or 20, wherein the one or more simulations are generated, at least in part, using one or more content creation applications of a three-dimensional (3D) content collaboration platform for 3D assets.

Clause 22. The system of clause 21, wherein the one or more simulations represent one or more simulated environments in at least one content creation application of the one or more content creation applications using an OpenUSD format.

Clause 23. The system of clause 19 or 20, wherein at least one foundation model of the one or more foundation models is accessible to one or more remote clients via at least one of an application programming interface (API) or an application plug-in.

Clause 24. One or more processors comprising processing circuitry to store, in a networked file system in a hub data center, an updated version of a foundation model generated based at least on training, in parallel in one or more training clusters in at least one of the hub data center or one or more spoke data centers using supervised learning, instances of the foundation model with one or more learned skills or experiences applied from a set of learned skills or experiences stored in the networked file system.

Clause 25. The one or more processors of clause 24, wherein the processing circuitry is further to store, in the networked file system in the hub data center, one or more additional learned skills or experiences generated based at least on training, in parallel in one or more simulation clusters in at least one of the hub data center or the one or more spoke data centers using reinforcement learning, instances of the updated version of the foundation model.

Clause 26. The one or more processors of clause 24 or 25, wherein the processing circuitry is further to run the supervised learning and the reinforcement learning in one or more iterations of a cyclic workflow.

Clause 27. The one or more processors of clause 24, 25 or 26, wherein the hub data center and the one or more spoke data centers are connected in a hub-and-spoke model.

Clause 28. The one or more processors of clause 24, 25 or 26, wherein the one or more training clusters in the hub data center and the one or more simulation clusters in the one or more spoke data centers connect to the networked file system in the hub data center.

Clause 29. The one or more processors of clause 24, 25 or 26, wherein the one or more simulation clusters in the one or more spoke data centers connect to the networked file system in the hub data center via at least one a direct interconnect or a dedicated private link.

Clause 30. The one or more processors of clause 24, 25 or 26, wherein the processing circuitry is further to transmit the one or more additional learned skills or experiences from the one or more spoke data centers to the networked file system in the hub data center via at least one of a direct interconnect or a dedicated private link.

Clause 31. The one or more processors of clause 24, 25 or 26, wherein the hub data center and the one or more spoke data centers are hosted by different cloud service providers.

Clause 32. The one or more processors of clause 31, wherein the processing circuitry is further to transmit the one or more additional learned skills or experiences from the one or more spoke data centers to the networked file system in the hub data center via at least one of a direct interconnect or a dedicated private link provided by at least one of the different cloud service providers.

Clause 33. The one or more processors of clause 24, 25 or 26, wherein the processing circuitry is further to asynchronously back up at least one of the learned skills or experiences from the networked file system in the hub data center to object storage in the hub data center, and copy the at least one of the learned skills or experiences from the object storage to the networked file system based at least on one or more supervised learning jobs associated with the at least one of the learned skills or experiences.

Clause 34. The one or more processors of clause 24, 25 or 26, wherein the one or more training clusters in at least one of the hub data center or the one or more spoke data centers comprise a type of compute node equipped with one or more AI or deep learning accelerators.

Clause 35. The one or more processors of clause 24, 25 or 26, wherein the one or more simulation clusters in at least one of the hub data center or the one or more spoke data centers comprise a type of compute node equipped with one or more ray-tracing accelerators.

Clause 36. The one or more processors of clause 24, 25 or 26, wherein the processing circuitry is further to run the supervised learning in the hub data center and the reinforcement learning in the one or more spoke data centers in parallel in the one or more iterations of the cyclic workflow.

Clause 37. The one or more processors of clause 24, 25 or 26, wherein the processing circuitry is further to run the supervised learning using a set of real and synthetic videos as training data for the foundation model with the one or more additional learned skills or experiences applied.

Clause 38. The one or more processors of clause 24, 25 or 26, wherein at least one of the one or more processors are comprised in at least one of: a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially using cloud computing resources; a system using or deploying one or more inference microservices; or a system that incorporates one or more machine learning models deployed in a service or microservice along with an OS-level virtualization package (e.g., a container).

Clause 39. A method comprising operating one or more iterations of a loop comprising i) supervised learning jobs that generate one or more updated versions of a robotics foundation model based at least on training, in parallel in one or more training clusters in at least one of a hub data center or one or more spoke data centers, instances of the robotics foundation model with one or more learned skills or experiences applied from a set of learned skills or experiences retrieved from a networked file system in the hub data center, and ii) reinforcement learning jobs that store, in the networked file system in the hub data center, additional learned skills or experiences generated using instances of a simulation environment running in parallel in one or more simulation clusters in at least one of the hub data center or the one or more spoke data centers using instances of the updated version of the robotics foundation model.

Clause 40. The method of clause 39, wherein the one or more training clusters in the hub data center and the one or more simulation clusters in the one or more spoke data centers connect to the networked file system in the hub data center.

Clause 41. The method of clause 39, wherein the method is performed by at least one of: a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially using cloud computing resources; a system using or deploying one or more inference microservices; or a system that incorporates one or more machine learning models deployed in a service or microservice along with an OS-level virtualization package (e.g., a container).

Clause 42. A system comprising one or more processors to store, in a networked file system in a hub data center, an updated version of a foundation model generated based at least on training instances of the foundation model, with one or more learned skills or experiences applied from a set of learned skills or experiences stored in the networked file system, in parallel in one or more training clusters in at least one of the hub data center or one or more spoke data centers using supervised learning.

Clause 43. The system of clause 42, wherein at least some learned skills or experiences of the set of learned skills or experiences are generated in parallel in one or more simulation clusters in at least one of the hub data center or the one or more spoke data centers using reinforcement learning to train the updated version of the foundation model using one or more simulations rendered using one or more light transport simulation algorithms.

Clause 44. The system of clause 42 or 43, wherein the one or more simulations are generated, at least in part, using one or more content creation applications of a three-dimensional (3D) content collaboration platform for 3D assets.

Clause 45. The system of clause 44, wherein the one or more simulations represent one or more simulated environments in at least one content creation application of the one or more content creation applications using an OpenUSD format.

Clause 46. The system of clause 42 or 43, wherein at least one foundation model of the one or more foundation models is accessible to one or more remote clients via at least one of an application programming interface (API) or an application plug-in.

What is claimed is:

1. One or more processors comprising processing circuitry to:
generate an updated version of a robotics foundation model based at least on training instances of the robotics foundation model in parallel in one or more training clusters in at least one of a hub data center or one or more spoke data centers using supervised learning and training data comprising a set of synthetic videos retrieved from a networked file system in the hub data center;
store, in the networked file system in the hub data center, one or more additional synthetic videos generated based at least on performing synthetic data generation using instances of a simulation environment running in parallel in one or more simulation clusters in at least one of the hub data center or the one or more spoke data centers; and
run the supervised learning and the synthetic data generation in one or more iterations of a cyclic workflow.

2. The one or more processors of claim 1, wherein the hub data center and the one or more spoke data centers are connected in a hub-and-spoke model.

3. The one or more processors of claim 1, wherein the one or more training clusters in the hub data center and the one or more simulation clusters in the one or more spoke data centers connect to the networked file system in the hub data center.

4. The one or more processors of claim 1, wherein the one or more simulation clusters in the one or more spoke data centers connect to the networked file system in the hub data center via at least one a direct interconnect or a dedicated private link.

5. The one or more processors of claim 1, wherein the processing circuitry is further to transmit the one or more additional synthetic videos from the one or more spoke data centers to the networked file system in the hub data center via at least one of a direct interconnect or a dedicated private link.

6. The one or more processors of claim 1, wherein the hub data center and the one or more spoke data centers are hosted by different cloud service providers.

7. The one or more processors of claim 6, wherein the processing circuitry is further to transmit the one or more additional synthetic videos from the one or more spoke data centers to the networked file system in the hub data center via at least one of a direct interconnect or a dedicated private link provided by at least one of the different cloud service providers.

8. The one or more processors of claim 1, wherein the processing circuitry is further to asynchronously back up one or more of the synthetic videos from the networked file system in the hub data center to object storage in the hub data center, and copy the one or more of the synthetic videos from the object storage to the networked file system based at least on one or more supervised learning jobs associated with the one or more of the synthetic videos.

9. The one or more processors of claim 1, wherein the one or more training clusters in at least one of the hub data center or the one or more spoke data centers comprise a type of compute node equipped with one or more AI or deep learning accelerators.

10. The one or more processors of claim 1, wherein the one or more simulation clusters in the one or more spoke data centers comprise a type of compute node equipped with one or more ray-tracing accelerators.

11. The one or more processors of claim 1, wherein the processing circuitry is further to run the supervised learning in the hub data center and the synthetic data generation in the one or more spoke data centers in parallel in the one or more iterations of the cyclic workflow.

12. The one or more processors of claim 1, wherein the processing circuitry is further to run the supervised learning using a set of real videos that form a portion of the training data that increases with successive iterations of the one or more iterations of the cyclic workflow.

13. The one or more processors of claim 1, wherein at least one of the one or more processors are comprised in at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially using cloud computing resources;
a system using or deploying one or more inference microservices; or a system that incorporates one or more machine learning models deployed in a service or microservice along with an OS-level virtualization package (e.g., a container).

14. A method comprising:
operating one or more iterations of a loop comprising i) supervised learning jobs that generate one or more updated versions of a robotics foundation model based at least on training, in parallel in one or more training clusters in at least one of a hub data center or one or more spoke data centers, instances of the robotics foundation model using training data comprising a set of synthetic videos retrieved from a networked file system in the hub data center, and ii) synthetic data generation jobs that store, in the networked file system in the hub data center, additional synthetic videos generated using instances of a simulation environment running in parallel in one or more simulation clusters in at least one of the hub data center or the one or more spoke data centers.

15. The method of claim 14, wherein the one or more training clusters in the hub data center and the one or more simulation clusters in the one or more spoke data centers connect to the networked file system in the hub data center.

16. The method of claim 14, wherein the method is performed by at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially using cloud computing resources;
a system using or deploying one or more inference microservices; or
a system that incorporates one or more machine learning models deployed in a service or microservice along with an OS-level virtualization package (e.g., a container).

17. A system comprising:
one or more processors to store, in a networked file system in a hub data center, an updated version of a robotics foundation model generated based at least on training instances of the robotics foundation model in parallel in one or more training clusters in at least one of a hub data center or one or more spoke data centers using supervised learning and training data comprising a set of synthetic videos retrieved from the networked file system in the hub data center;
at least some synthetic videos of the set of synthetic videos generated in parallel in one or more simulation clusters in at least one of the hub data center or the one or more spoke data centers using one or more simulations rendered using one or more light transport simulation algorithms.

18. The system of claim 17, wherein the one or more simulations are generated, at least in part, using one or more content creation applications of a three-dimensional (3D) content collaboration platform for 3D assets.

19. The system of claim 18, wherein the one or more simulations represent one or more simulated environments in at least one content creation application of the one or more content creation applications using an OpenUSD format.

20. The system of claim 17, wherein at least one foundation model of the one or more foundation models is accessible to one or more remote clients via at least one of an application programming interface (API) or an application plug-in.
